(19) United States
(12) Patent Application Publication
(10) Pub. No.: US 2018/0367843 A1
(43) Pub. Date: Dec. 20, 2018

(54) ELECTRONIC DEVICE FOR PLAYING CONTENTS AND OPERATING METHOD THEREOF

(71) Applicant: Samsung Electronics Co., Ltd., Suwon-si (KR)

(72) Inventor: Chulho HAN, Seoul (KR)

(21) Appl. No.: 16/013,354

(22) Filed: Jun. 20, 2018

(30) Foreign Application Priority Data
Jun. 20, 2017 (KR) 10-2017-0077817

(51) Int. Cl. H04N 21/436; H04L 12/28; H04N 21/214; H04N 21/414; H04N 21/41

(52) U.S. Cl. CPC H04N 21/43615; H04L 12/2809; H04N 21/2143; H04L 2012/2849; H04N 21/4126; H04L 12/2838; H04L 12/2812; H04N 21/41407

(57) ABSTRACT

An electronic device for playing a content and an operation method thereof is provided. The electronic device includes a display, a communication interface, a memory, and at least one processor electrically connected with the display, the communication interface, and the memory. The memory stores instructions that, when executed, cause the at least one processor to control to display on the display operation-related information of at least one environment creation device corresponding to a content in response to a content playing event being detected, to set an operation mode of the at least one environment creation device, and to control the at least one environment creation device based on the set operation mode through the communication interface. Other embodiments are possible.

### CROSS-REFERENCE TO RELATED APPLICATION(S)

This application is based on and claims priority under 35 U.S.C. § 119(a) of a Korean patent application number 10-2017-0077817, filed on Jun. 20, 2017, in the Korean Intellectual Property Office, the disclosure of which is incorporated by reference herein in its entirety.

### BACKGROUND

### 1. Field

The disclosure relates to an electronic device for playing contents and a method thereof.

### 2. Description of the Related Art

With the development of information and communication technology and semiconductor technology, various types of electronic devices provide various functions. For example, various functions may include multimedia services such as a voice call service, a message service, a broadcasting service, a wireless Internet service, a camera service, a video playing service, and a music playing service.

An electronic device can share contents with other electronic devices and play the contents. For example, a smart phone may provide image data of a video content to a television (TV), and may provide audio data to a speaker, thereby allowing the image data and the audio data of the video content to be outputted through the TV and the speaker, respectively.

The above information is presented as background information only to assist with an understanding of the disclosure. No determination has been made, and no assertion is made, as to whether any of the above might be applicable as prior art with regard to the disclosure.

### SUMMARY

An electronic device may share a content with neighboring electronic devices and play the contents in order to augment a user's content appreciation experience. However, the user's content appreciation experience may be hindered by other neighboring electronic devices that do not share the contents with the electronic device. For example, when an electronic device shares a music content with a first neighboring electronic device and plays the content, a noise generated at a second neighboring electronic device may hinder a user's music content appreciation experience.

In addition, the electronic device may select a neighboring electronic device to share and play a content. However, when there is a plurality of user electronic devices like a home environment, the neighboring electronic device may have been occupied by other user electronic devices. Since the electronic device and other user electronic devices cannot use the same neighboring electronic device simultaneously, there may be inconvenience that the user of the electronic device should directly identify whether the neighboring electronic devices are occupied by other user electronic devices, and then should select a neighboring electronic device to use.

Aspects of the disclosure are to address at least the above-mentioned problems and/or disadvantages and to provide at least the advantages described below. Accordingly, an aspect of the disclosure is to provide an apparatus and a method for controlling an operation of a neighboring electronic device that hinders a content appreciation experience in an electronic device.

Another aspect of the disclosure is to provide an apparatus and a method for sharing a content with a neighboring electronic device in an electronic device, based on whether the neighboring electronic device is used by another user.

Additional aspects will be set forth in part in the description which follows and, in part, will be apparent from the description, or may be learned by practice of the presented embodiments.

In accordance with an aspect of the disclosure, an electronic device is provided. The electronic device includes a display, a communication interface, a memory, and at least one processor electrically connected with the display, the communication interface, and the memory. The memory stores instructions that, when executed, cause the at least one processor to display on the display operation-related information of at least one environment creation device corresponding to a content in response to a content playing event being detected, to set an operation mode of the at least one environment creation device, and to control the at least one environment creation device based on the set operation mode through the communication interface.

In accordance with another aspect of the disclosure, a server is provided. The server includes a communication interface, a memory, and at least one processor operatively connected with the communication interface and the memory. The memory stores instructions that, when executed, cause the at least one processor to receive content information from an electronic device, and to control the communication interface to transmit operation-related information regarding at least one environment creation device corresponding to the content to the electronic device, in response to the content information being received from the electronic device.

In accordance with another aspect of the disclosure, an operating method of an electronic device is provided. The operating method includes in response to a content playing event being detected, displaying on a display of the electronic device operation-related information of at least one environment creation device corresponding to a content, setting an operation mode of the at least one environment creation device, and controlling the at least one environment creation device based on the set operation mode through the communication interface.

In accordance with another aspect of the disclosure, an operating method of a server is provided. The operating method includes receiving content information from an electronic device, and, in response to the content information being received from the electronic device, transmitting operation-related information regarding at least one environment creation device corresponding to the content to the electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating a system structure according to various embodiments of the disclosure;

FIG. 2 is a view illustrating a system structure in a home network environment according to various embodiments of the disclosure;

FIG. 3 is a view illustrating a data model for controlling neighboring electronic devices according to various embodiments of the disclosure;

FIG. 4 is a view illustrating an electronic device in a network environment according to various embodiments of the disclosure;

FIG. 5 is a block diagram illustrating an electronic device according to various embodiments of the disclosure;

FIG. 6 is a block diagram illustrating a program module according to various embodiments of the disclosure;

FIG. 7 is a view illustrating a server in a network environment according to various embodiments of the disclosure;

FIG. 8 is a view illustrating an operation procedure for controlling a neighboring electronic device when a content is played in an electronic device according to various embodiments of the disclosure;

FIG. 9 is a view illustrating an operation procedure for displaying information regarding a neighboring electronic device in an electronic device according to various embodiments of the disclosure;

FIG. 10 is a view illustrating a screen configuration for playing and sharing a content in an electronic device according to various embodiments of the disclosure;

FIG. 11 is a view illustrating a screen configuration for playing and sharing a content in an electronic device according to various embodiments of the disclosure;

FIGS. 12A and 12B are views illustrating a screen configuration displaying information regarding neighboring electronic devices in an electronic device according to various embodiments of the disclosure;

FIGS. 13A, 13B, and 13C are views illustrating a screen configuration displaying whether neighboring electronic devices are used by other users in an electronic device according to various embodiments of the disclosure;

FIG. 14 is a view illustrating an operation procedure for setting an operation mode of a neighboring electronic device in an electronic device according to various embodiments of the disclosure;

FIGS. 15A and 15B are views illustrating a screen configuration for setting an operation mode of a neighboring electronic device in an electronic device according to various embodiments of the disclosure;

FIG. 16 is a view illustrating an operation procedure for setting a neighboring electronic device to output a content in an electronic device according to various embodiments of the disclosure;

FIG. 17A is a view illustrating a screen configuration for setting a neighboring electronic device to output a content in an electronic device according to various embodiments of the disclosure;

FIG. 17B is a view illustrating a screen configuration showing that authority to use a neighboring electronic device is lost in another electronic device according to various embodiments of the disclosure;

FIGS. 18A, 18B, 18C, and 18D are views illustrating a screen configuration for taking over authority to use a neighboring electronic device based on a priority in an electronic device according to various embodiments of the disclosure;

FIGS. 19A, 19B, and 19C are views illustrating a screen configuration for using a neighboring electronic device based on a priority in an electronic device according to various embodiments of the disclosure;

FIG. 20 is a view illustrating an operation procedure in a server device for controlling a neighboring electronic device to play a content of an electronic device according to various embodiments of the disclosure;

FIG. 21 is a view illustrating an operation procedure for transmitting information regarding a recommended neighboring electronic device in a server device according to various embodiments of the disclosure;

FIG. 22 is a view illustrating an operation procedure for controlling a neighboring electronic device based on determination by an electronic device in a server device according to various embodiments of the disclosure;

FIG. 23 is a view illustrating an operation procedure for restoring a state of a neighboring electronic device in a server device according to various embodiments of the disclosure; and

FIGS. 24 and 25 are views illustrating an example in which a state of a neighboring electronic device is restored in a server device at a time when playing of a content of an electronic device is ended according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, each of such phrases as “A or B” or “at least one of A and/or B” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly or via another element (e.g., a third element).

The term “configured (or set) to . . . ” used in the disclosure may be interchangeably used with the terms “suitable for . . . ,” “having the capacity to . . . ,” “designed to . . . ,” “adapted to . . . ,” “made to . . . ,” or “capable of . . . ” in a hardware or software level depending on the situation. In a certain situation, the term “a device configured to . . . ” may refer to “the device being capable of . . . ” with another device or parts. For example, “a processor configured (set) to perform A, B, and C” may refer, for example, and without limitation, to a dedicated processor (for example, an embedded processor) for performing a corresponding operation, or a generic-purpose processor (for example, a central processing unit (CPU) or an application processor (AP)), or the like, for performing corresponding operations by executing one or more software programs stored in a memory device.

An electronic device according to various embodiments of the disclosure may include at least one of smartphones, tablet personal computers (PCs), mobile phones, video telephones, electronic book readers, desktop PCs, laptop PCs, netbook computers, workstations, servers, PDAs, portable multimedia players (PMPs), Motion Picture Experts Group (MPEG-1 or MPEG-2) audio layer 3 (MP3) players, medical devices, cameras, or wearable devices, or the like, but is not limited thereto. The wearable devices may include at least one of accessories (for example, watches, rings, bracelets, ankle bracelets, necklaces, glasses, contact lenses, head-mounted-devices (HMDs), etc.), fabric- or clothing-mounted devices (for example, electronic apparels), body-mounted devices (for example, skin pads, tattoos, etc.), bio-implantable circuits, or the like, but are not limited thereto.

According to embodiments, the electronic devices may include at least one of, for example, televisions (TVs), digital video disc (DVD) players, audios, refrigerators, air conditioners, cleaners, ovens, microwave ovens, washing machines, air cleaners, set-top boxes, home automation control panels, security control panels, media boxes (for example, Samsung HomeSync™, Apple TV™, or Google TV™), game consoles (for example, Xbox™ and PlayStation™), electronic dictionaries, electronic keys, camcorders, electronic picture frames, or the like, but are not limited thereto.

According to another embodiment, the electronic devices may include at least one of medical devices (for example, various portable medical measurement devices (for example, a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, global navigation satellite systems (GNSS), event data recorders (EDRs), flight data recorders (FDRs), vehicle infotainment devices, electronic equipment for vessels (for example, navigation systems and gyrocompasses), avionics, security devices, head units for vehicles, industrial or home robots, drones, automatic teller's machines (ATMs) of financial institutions, points of sales (POSs) of stores, or internet of things (for example, light bulbs, various sensors, sprinkler devices, fire alarms, thermostats, street lamps, toasters, exercise equipment, hot water tanks, heaters, boilers, and the like), or the like, but are not limited thereto.

According to an example embodiment, the electronic devices may include at least one of furniture, a part of buildings/structures or cars, electronic boards, electronic signature receiving devices, projectors, or various measuring instruments (for example, water meters, electricity meters, gas meters, or wave meters, and the like), or the like, but are not limited thereto. The electronic devices according to various embodiments may be flexible or may be a combination of two or more devices of the above-mentioned devices. Also, electronic devices according to various embodiments of the disclosure are not limited to the above-mentioned devices. In the disclosure, the term “user” may refer to a person who uses the electronic device or a device that uses the electronic device (for example, an artificial intelligence electronic device).

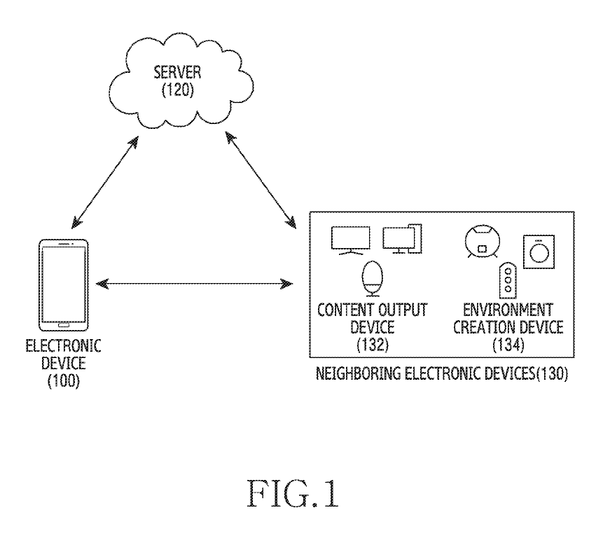

FIG. 1 is a view illustrating a system structure according to various embodiments of the disclosure.

The system according to various embodiments may include an electronic device 100, a server 120, and neighboring electronic devices 130. According to various embodiments, the electronic device 100 may be an electronic device that includes an application related to playing of a content, or includes a function for providing various services by accessing the Internet (for example, a smart hub function). The neighboring electronic devices 130 may be divided into a content output device 132 and an environment creation device 134. The content output device 132 may refer to a neighboring electronic device that can play and/or output a multimedia content. The content output device 132 may include, for example, a TV, a speaker, a sound bar, a tablet, a PC, a smart phone, or a refrigerator. The environment creation device 134 may refer to a neighboring electronic device that is related to temperature, light, or sound, and may influence a content playing environment of the electronic device 100. The environment creation device 134 may include, for example, an air conditioner, an air purifier, a robot cleaner, a washing machine, a lighting device, a sensor, a motor, a printer, a facsimile machine, or an air conditioning system. According to various embodiments, a portion of the neighboring electronic devices 130 may be classified as the content output device or the environment creation device depending on a situation. For example, the speaker is able to play and/or output a multimedia content and thus may be classified as the content output device, and also, may be classified as the environment creation device since audio data outputted from the speaker may influence a content playing environment.

According to various embodiments, the electronic device 100 may receive recommendation convergence configuration information for playing a content from the server 120, and may play a content in cooperation with at least one neighboring electronic device 130 based on the received recommendation convergence configuration information. The recommendation convergence configuration information may include at least one of information of a content output device that is recommended to play the content, and information of an environment creation device. According to an embodiment, the electronic device 100 may select at least one content output device based on the recommendation convergence configuration information received from the server 120, and may connect communication with the selected content output device and share and play the content. For example, the electronic device 100 may receive information on the TV, the speaker, and the PC as recommendation convergence configuration information for playing a video content. The electronic device 100 may selected the TV and the speaker and connect communication therewith, and may output image data of the video content through the TV and may output audio data of the video content through the speaker. According to an embodiment, the electronic device 100 may determine whether to share the content with the corresponding content output device, by considering whether the content output device is used by another user (or another electronic device).

According to an embodiment, the electronic device 100 may control an operation mode of at least one environment creation device, based on the recommendation convergence configuration information received from the server 120. For example, the electronic device 100 may receive, from the server 120, information regarding a current operation mode and/or a recommendation operation mode of the air conditioner, the robot cleaner, and the lighting device, as recommendation convergence configuration information for playing a video content. The electronic device 100 may control the air conditioner, the robot cleaner, and the lighting device to operate in recommend operation modes (for example, modes of Air conditioner-air volume: Low, Robot cleaner-Temporary cleaning stop, and Lighting device-Off) based on a user input, or to operate in other modes set by a user input. According to an embodiment, the electronic device 100 may determine whether to control the operation mode of the corresponding environment creation device, by considering a user (or an electronic device) corresponding to a current operation mode of the environment creation device. For example, when the robot cleaner is currently working in a cleaning mode, the electronic device 100 may display, on the screen, information of a user instructing the robot cleaner to operate in the cleaning mode, such that the user of the electronic device 100 can refer to the user information in controlling the operation mode of the robot cleaner.

According to various embodiments, the server 120 may receive content information from the electronic device 100, and may generate recommendation convergence configuration information based on the received content information. The content information may include, for example, a content type, metadata of the content, attribute information of the content, or the like. The server 120 may generate the recommendation convergence configuration information of the electronic device 100, based on the content information, a convergence configuration designated by the user, a using history, real-time states of the neighboring electronic devices, a location of the electronic device 100, locations of the neighboring electronic devices, time, or a combination thereof. The server 120 may transmit, to the electronic device 100, the recommendation convergence configuration information including at least one of the content output device and the environment creation device. According to an embodiment, the recommendation convergence configuration information may include information indicating whether the content output device is used by another user, priority information of another user, and/or priority information of an electronic device corresponding to another user. According to an embodiment, the recommendation convergence configuration information may include information indicating a current operation mode and/or a recommendation operation mode of the environment creation device. According to an embodiment, the recommendation convergence configuration information may include information of a user corresponding to the current operation mode of the environment creation device.

According to various embodiments, the server 120 may receive a response signal to the recommendation convergence configuration information from the electronic device 100. The server 120 may identify a content output device selected by the electronic device 100 based on the received response signal, and may transmit a control signal for connecting communication with the electronic device 100 to the identified content output device. The server 120 may identify an operation mode of at least one environment creation device based on the received response signal, and may transmit a control signal based on the identified operation mode to the at least one environment creation device.

According to various embodiments, the server 120 may detect a content playing end event of the electronic device 100, and may restore states of the neighboring electronic devices 130 to previous states. For example, the server 120 may store information related to current states of the neighboring electronic devices 130 at the time of generating the recommendation convergence configuration information, and, when playing of the content of the electronic device 100 is ended, the server 120 may restore the states of the neighboring electronic devices 130 based on the stored information related to the current states. The information related to the current states may include at least one of, for example, state information of a corresponding neighboring electronic device, log information of an application which is being executed, user account information, communication connection information, and task-related information. The state information may include a task performing situation, information on an error and a breakdown, an operation mode and a detail setting mode, and an on/off state.

The neighboring electronic devices 130 may transmit the state information to the server 120. The neighboring electronic devices 130 may periodically transmit the state information to the server 120 or may transmit the state information to the server 120 every time the state information is changed or a specific event occurs. At least one of the neighboring electronic devices 130 may connect communication with the electronic device 100 according to a control signal received from the server 120, and may output data regarding at least one content provided by the electronic device 100. At least one of the neighboring electronic devices 130 may change an operation mode according to a control signal received from the server 120.

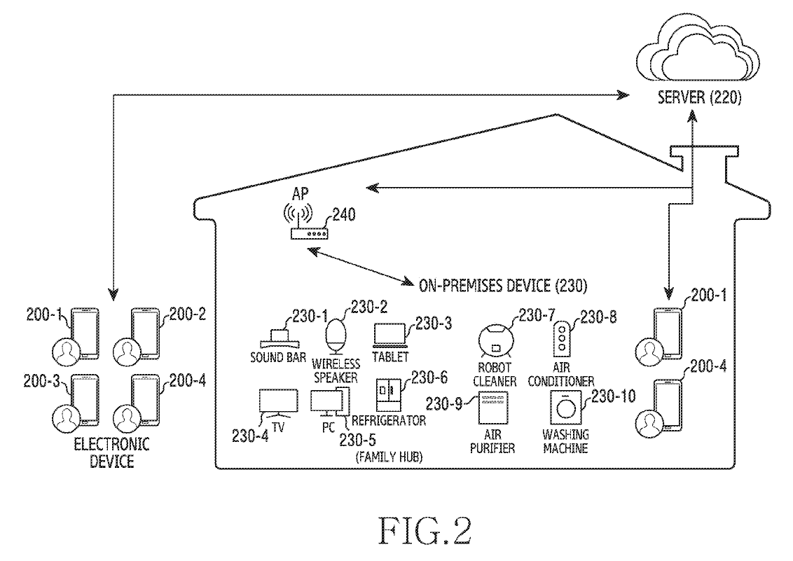

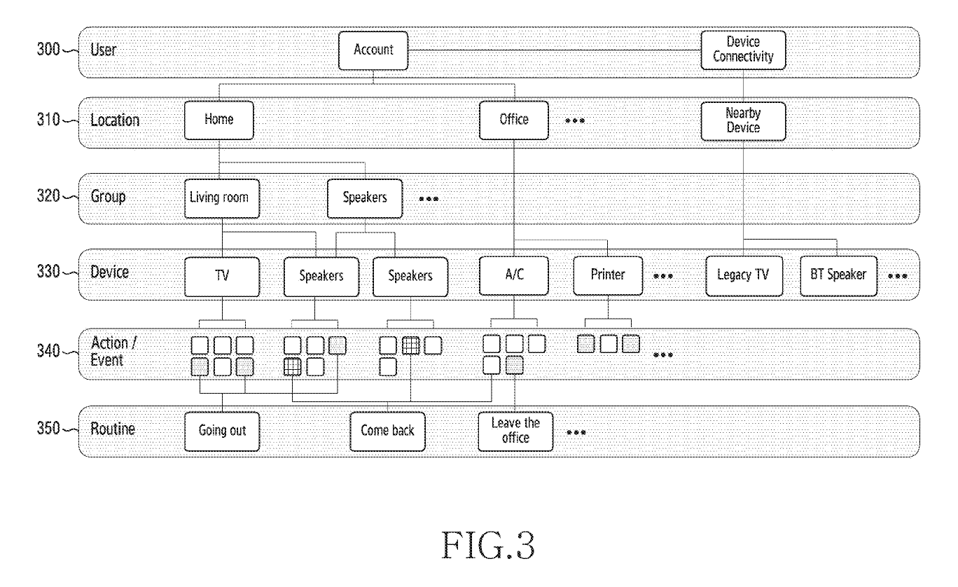

FIG. 2 is a view illustrating a system structure in a home network environment according to various embodiments of the disclosure, and FIG. 3 is a view illustrating a data model for controlling neighboring electronic devices according to various embodiments of the disclosure.

Referring to FIGS. 2 and 3, in a home network environment, a system may include a plurality of electronic devices 200-1 to 200-4, a server 220, an on-premises device 230, and an AP 240. Each of the plurality of electronic devices 200-1 to 200-4 may be the electronic device 100 of FIG. 1. The server 220 may be the server 120 of FIG. 1. The on-premises device 230 may include, for example, a sound bar 230-1, a wireless speaker 230-2, a tablet 230-3, a TV 230-4, a PC 230-5, a refrigerator 230-6, a robot cleaner 230-7, an air conditioner 230-8, an air purifier 230-9, a washing machine 230-10, etc. The on-premises device may be the neighboring electronic devices 130 of FIG. 1. The AP 240 may be an electronic device that is provided with a smart hub function of accessing the Internet.

According to various embodiments, each of the plurality of electronic devices 200-1 to 200-4 may register user's account information at the server 120. For example, each of the plurality of electronic devices 200-1 to 200-4 may receive account information (for example, user identification information, a password, etc.) from the user by using an application (for example, a smart home application) for controlling the on-premises device 230, and may transmit the input account information to the server 220. The account information is a collection of information defining resource access authority, and each of the plurality of electronic devices 200-1 to 200-4 may be related to one or more pieces of account information. According to an embodiment, each of the plurality of electronic devices 200-1 to 200-4 may register user's profile information (for example, a name, a nickname, sex, a phone number, etc.) at the server 120.

According to various embodiments, each of the plurality of electronic devices 200-1 to 200-4 may register at least one on-premises device 230 at the server 220. For example, when initially detecting at least one on-premises device 230, each of the plurality of electronic devices 200-1 to 200-4 may transmit identification information of the detected on-premises device 230 to the server 220 along with the user account information. When initially detecting at least one on-premises device 230, each of the plurality of electronic devices 200-1 to 200-4 may transmit information (for example, AP identification information, a password for accessing the AP) for connecting short-range communication with the AP 240 to the detected on-premises device 230, and may control the detected on-premises device 230 to access the AP 240 and to be connected with the server 220. Each of the plurality of electronic devices 200-1 to 200-4 may detect the on-premises device 230 based on a signal received from the on-premises device 230. Each of the plurality of electronic devices 200-1 to 200-4 may detect at least one on-premises device 230 by transmitting and receiving search signals based on a user input using a control application of the on-premises device 230. According to an embodiment, each of the plurality of electronic devices 200-1 to 200-4 may register location information of the at least one on-premises device 230 at the server 220. Each of the plurality of electronic devices 200-1 to 200-4 may receive location information of the on-premises device 230 from the user, or may set its own location information at the time of detecting the on-premises device 230 as the location information of the on-premises device 230. Each of the plurality of electronic devices 200-1 to 200-4 may register the at least one on-premises device 230 at the server 220.

According to various embodiments, each of the plurality of electronic devices 200-1 to 200-4 may delete or change information regarding the at least one on-premises device 230 registered at the server 220. For example, each of the plurality of electronic devices 200-1 to 200-4 may transmit additional information or changed information regarding the on-premises device 230 to the server 220 based on a user input through a user interface. In another example, each of the plurality of electronic devices 200-1 to 200-4 may change location information of the at least one on-premises device 230 registered at the server 220. In another example, each of the plurality of electronic devices 200-1 to 200-4 may delete information regarding the at least one on-premises device 230 registered at the server 220.

According to various embodiments, each of the plurality of electronic devices 200-1 to 200-4 may remotely control the at least one on-premises device 230 through the server 220. For example, each of the plurality of electronic devices 200-1 to 200-4 may remotely control the at least one on-premises device 230 based on a data model as shown in FIG. 3. The data model may have at least one piece of user account information 300 related to a corresponding electronic device, and electronic device information related to user account information. The data model may include at least one piece of location information 310 related to the user account information 300, at least one piece of group information 320 related to each location, information 330 regarding neighboring electronic devices belonging to each group, actions and/or events 340 regarding each of the neighboring electronic devices, and information 350 regarding at least one routine for performing actions and/or events regarding each of the neighboring electronic devices. For example, when it is automatically detected that a first routine is performed or activation of the first routine is detected by a user input through an application which is being executed in the electronic device 200-1, the electronic device 200-1 may control at least one neighboring electronic device to perform an action and/or an event corresponding to the first routine based on the data model. When activation of a routine “going out” indicating going out from a main room is detected through an application which is being executed, the electronic device 200-1 may identify that an action related to the routine “going out” is “Power Off,” and may turn off power of the TV and the speaker related to the routine “going out.” The data model shown in FIG. 3 is merely an example and the disclosure is not limited thereto. For example, the data model may be designed in such a manner that the neighboring electronic devices 330 related to each user account information 300 are not classified by the location information 310 and/or the group 320, and are directly related to the user account information 300.

According to various embodiments, when the electronic devices 200-1 to 200-4 located at home from among the plurality of electronic devices 200-1 to 200-4 are playing contents, the electronic devices may receive recommendation convergence configuration information including information regarding the at least one on-premises device 230 from the server 220. The electronic devices 200-1 to 200-4 located at home may receive information regarding at least one of a content output device and an environment creation device from among the on-premises devices 230 located nearby from the server 220. The electronic devices 200-1 to 200-4 located at home may connect communication with at least one of the on-premises devices 230 based on the received information, and may share and play contents, and may control an operation mode of at least one of the on-premises devices 230. For example, the electronic device 200-1 located at home may connect communication with the wireless speaker 230-2 and may play a music content, and may control the robot cleaner 230-7 to temporarily stop a cleaning operation while the music content is being played.

According to various embodiments, the server 220 may manage user account information registered by each of the plurality of electronic devices 200-1 to 200-4. The server 220 may map information of an electronic device which registered user account information onto the corresponding user account information, and may manage the mapped information. The server 220 may obtain and store at least one piece of location information related to each user account, based on location information received from each of the plurality of electronic devices 200-1 to 200-4. The server 220 may identify on-premises devices 230 related to the user account based on a signal received from each of the plurality of electronic devices 200-1 to 200-4. For example, the server 220 may determine and manage on-premises devices 230 communicable with the electronic device 200-1 having a first user account, and/or on-premises devices 230 which are controllable by the electronic device 200-1 having the first user account, based on a signal received from the electronic device 200-1 having the first user account. According to various embodiments, the server 220 may manage and control on-premises devices 230 corresponding to at least one location (for example, home, office, institute, etc.) according to each user account. According to various embodiments, the server 220 may manage at least one piece of location information related to the user account, and may manage the on-premises devices corresponding to each location information as a group. For example, the server 220 may classify on-premises device corresponding to a home location of the first user account into the same group as that of the main room, a living room, or speakers, and may manage the on-premises devices. According to various embodiments, the server 220 may generate and manage a routine to control an action and an event regarding on-premises devices related to the user account. For example, the server 220 may include the data model as shown in FIG. 3, and, when a specific routine is detected by any one of the plurality of electronic devices 200-1 to 200-4 based on the data model, the server 220 may control the on-premises device by using actions and events related to the corresponding user account and the corresponding routine. For example, when the routine “going out” indicating going out from the main room is detected by the electronic device 200-1 having the first user account, the server 220 may identify that the action related to the routine “going out” is “Power Off” and may turn off the power of the TV and the speaker related to the routine “going out”.

According to various embodiments, the server 220 may receive content information from each of the plurality of electronic devices 200-1 to 200-4, and may generate recommendation convergence configuration information based on the received content information. The server 220 may transmit the generated recommendation convergence configuration information to a corresponding electronic device. According to an embodiment, the server 220 may identify whether a content output device is used by another electronic device at the time of generating the recommendation convergence configuration information, and, when the corresponding content output device is being used by another electronic device, may generate recommendation convergence configuration information based on user account information of another electronic device. For example, when the sound bar 230-1, the wireless speaker 230-2, and the TV 230-4 are selected according to a content type, and the TV 230-4 is being used by another electronic device 200-4 related to a second user account, the server 220 may generate recommendation convergence configuration information indicating “Content output device: sound bar 230-1, wireless speaker 230-2, and TV 230-4—occupied by the second user account.” According to an embodiment, the server 220 may determine priorities of the users and/or priorities of electronic devices corresponding to the users, and may generate recommendation convergence configuration information based on the user priority and/or the priority of the electronic devices. For example, when the TV 230-4 is selected to play a content of the electronic device 200-1 related to the first user account, but the TV 230-4 is being used by another electronic device 200-4 related to the second user account, the server 220 may determine whether to include the TV 230-4 in the recommendation convergence configuration information, based on the priorities of the first user account and the second user account. For example, when the priority of the first user account is higher than the priority of the second user account, the server 220 may generate recommendation convergence configuration information indicating “Content output device: sound bar 230-1, wireless speaker 230-2, and TV 230-4—occupied by the second user account.” In another example, when the priority of the first user account is lower than the priority of the second user account, the server 220 may exclude the TV 230-4 which is being used by the second user account, and may generate recommendation convergence configuration information indicating “Content output device: sound bar 230-1 and wireless speaker 230-2.” For example, when the TV 230-4 is selected to play the content of the electronic device 200-1 related to the first user account, but the TV 230-4 is being used by another electronic device 200-4 related to the second user account, the server 220 may determine whether to include the TV 230-4 in recommendation convergence configuration information, based on the priorities of the electronic device 200-1 related to the first user account and another electronic device 200-4 related to the second user account. For example, when the priority of the electronic device 200-1 related to the first user account is higher than the priority of another electronic device 200-4 related to the second user account, the server 220 may generate recommendation convergence configuration information indicating “Content output device: sound bar 230-1, wireless speaker 230-2, and TV 230-4—occupied by the second user account.” In another example, when the priority of the electronic device 200-1 related to the first user account is lower than the priority of another electronic device 200-4 related to the second user account, the server 220 may exclude the TV 230-4 which is being used by the second user account, and may generate recommendation convergence configuration information indicating “Content output device: sound bar 230-1 and wireless speaker 230-2.” According to various embodiments, the server 220 may include information regarding a priority of a user account which is using a content output device, and/or a priority of an electronic device related to the user account in the recommendation convergence configuration information.

According to various embodiments, the server 220 may receive state information from the on-premises devices 230 through the AP 240. The state information may be periodically received from the on-premises devices 230, or may be received when the state information is changed or when a specific event occurs. For example, the server 220 may receive, from the on-premises devices 230, state messages which are classified as shown in table 1 presented below, and may store and change the state information of the on-premises devices 230 based on the received message:

TABLE 1

| | Sub | | Examples of state |
|---|---|---|---|
| Category | category | Sub-sub category | messages |
| Alert | Error | Error occurring | An error occurred in |
| | Alert | during a task | the robot cleaner |
| | | | during a cleaning |
| | | | operation. Please |
| | | | check the device. |
| | | | Mobile to TV ended. |
| | | | (Please check the |
| | | | power of the TV.) |
| | | Warning | The door of the |
| | | notification | refrigerator is open. |
| | | | The temperature of the |
| | | | refrigeration is very |
| | | | high. |
| | | | The battery of the |
| | | | robot cleaner is very |
| | | | low. |
| | | | The air conditioner is |
| | | | disconnected. (network |
| | | | error) |
| | Request | Update | There is a new version. |
| | confirmation | notification | Do you want to |
| | | | update? |
| | | Location | Mr./Miss. OOO has |
| | | invitation | invited you to “Modern |
| | | notification | House.” Do you want |
| | | | to accept? |
| | | Task extension | Cooking will be |
| | | confirmation | finished in 3 minutes. |
| | | | Do you want to add 5 |
| | | | minutes? (oven/range |
| | | | specialization function) |
| | Maintenance | Maintenance/user | Please replace the |
| | | behavior request | filter. (refrigerator) |
| | | | Please empty the dust |
| | | | container. (cleaner) |
| | | | A very small amount of |
| | | | detergent remains. |
| | | | (washing machine) |
| History | Device/ | Device working | Auto cleaning will be |
| | Contents | start | starting. Washing will |
| | status | | be starting. Range will |
| | | | be working. |
| | | Device working | Range has been |
| | | cancel/stop | stopped. Washing has |
| | | | been stopped. |
| | | Notification of | Cooking will be |
| | | device working | finished in 5 minutes. A |
| | | progress state | spin-dry mode will be |
| | | | starting. |
| | | Update of | Transmitting the third |
| | | Content | photo out of the 10 |
| | | | photos . . . |
| | Task | Device working | Normal washing has |
| | completion | completion | been finished. Cooking |
| | | | has been finished. |
| | | Content update | 10 photos have been |
| | | completion | updated. Mr./Miss. |
| | | | OOO has updated 10 |
| | | | photos. |
| | | Overall control | A sleeping mode has |
| | | (auto mode) | been executed. |
| | | execution | |
| Notice | Account | Location generation | “Modern House” has |
| | Management | | been generated. |
| | | Location deletion | “Modern House” has |
| | | | been deleted. |
| | | Notification of | Mr./Miss XXX |
| | | accept | accepted the invitation. |
| | | of invitation to | |
| | | location | |
| | | Notification of | Mr./Miss XXX left |
| | | leaving from | “Modern House.” |
| | | location | |
| | General | Device sharing | Washing machine of |
| | Notice | notification | Mr./Miss. OOO has |
| | | | been shared. (the |
| | | | singular) Three devices |
| | | | of Mr./Miss. OOO have |
| | | | been shared. (the plural |
| | | | form) |
| | | User presence | Arrived at Modern |
| | | change | House. |
| | | Device | Air conditioner is |
| | | connection/ | connected. Air |
| | | disconnection | conditioner is |
| | | | disconnected. |

According to various embodiments, the AP 240 may receive the state information from the on-premises devices 230 accessing the AP 240, and may transmit the received state information to the server 230. In addition, the AP 240 may transmit signals received from the server 230 to the on-premises devices 230.

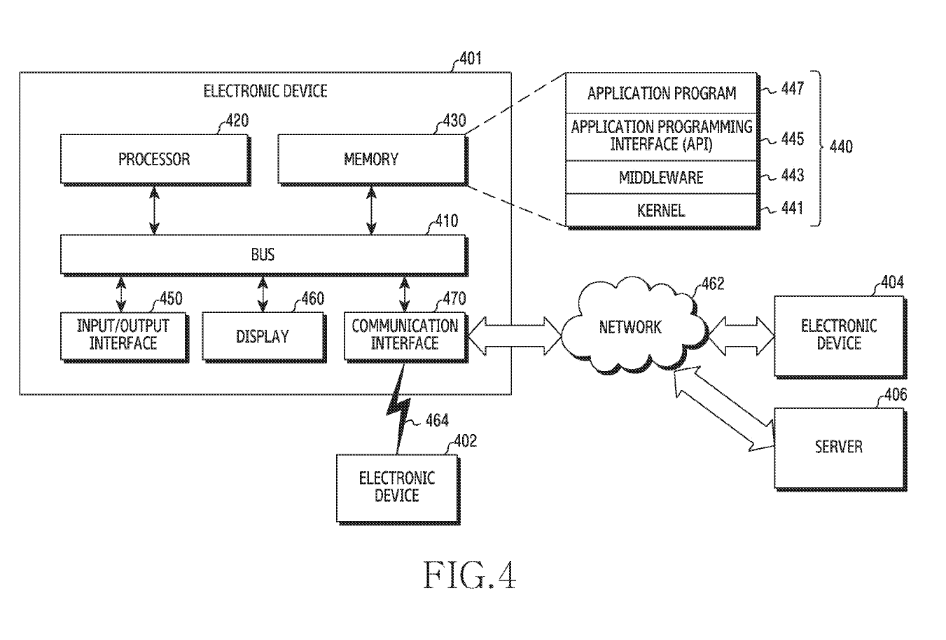

FIG. 4 is a block diagram illustrating an electronic device in a network environment according to various embodiments of the disclosure. The electronic device 401 of FIG. 4 may be any one of the electronic device 100 illustrated in FIG. 1 or the electronic devices 200-1 to 200-4 illustrated in FIG. 2.

Referring to FIG. 4, the electronic device 401 may include a bus 410, a processor 420, a memory 430, an input/output interface 450, a display 460, and a communication interface 470. According to an embodiment, the electronic device 401 may not include at least one of the above-described elements or may further include other element(s).

The bus 410 may interconnect the above-described elements 420-470 and may include a circuit for transmitting communications (for example, a control message and/or data) among the above-described elements.

The processor 420 may include one or more of a CPU, an AP, an image signal processor (ISP), or a communication processor (CP). The processor 420 may perform, for example, an operation or data processing associated with control and/or communication of at least one other element(s) of the electronic device 401.

According to various embodiments, the processor 420 may register user's account information at a server 406. For example, the processor 420 may execute an application for controlling other electronic devices based on a user input, and may receive user account information and/or profile information through the executed application. The processor 420 may transmit the inputted user account information and/or profile information to the server 220.

According to various embodiments, the processor 420 may detect a neighboring electronic device and may register the detected neighboring electronic device at the server 406. For example, the processor 420 may operate as an AP based on a user input, and may detect a neighboring electronic device accessing the AP, and may transmit information regarding the detected neighboring electronic device to the server 406. In another example, the processor 420 may detect a neighboring electronic device by receiving a signal from the neighboring electronic device through a specific communication method, and may transmit information regarding the detected neighboring electronic device to the server 406. According to an embodiment, the processor 420 may transmit information indicating that the electronic device 401 has authority to control the detected neighboring electronic device, while transmitting the information regarding the detected neighboring electronic device to the server 406. According to an embodiment, the processor 420 may transmit location information of the detected neighboring electronic device to the server 406. The processor 420 may directly receive the location information of the detected neighboring electronic device from the user through the input/output interface 450. The processor 420 may determine, as the location information of the detected neighboring electronic device, location information of the electronic device 401 corresponding to the time of detecting the neighboring electronic device. According to an embodiment, the processor 420 may transmit connection information with the neighboring AP (for example, AP identification information, an AP access password, etc.) to the detected neighboring electronic device, and may control the neighboring electronic device to access the neighboring AP and to maintain connection with the server 406.

According to various embodiments, the processor 420 may add, delete, or change the information regarding the neighboring electronic device registered at the server 406. For example, the processor 420 may display a user interface for changing the information regarding the neighboring electronic device on the display 460, and may add, change, or delete information regarding at least one neighboring electronic device based on a user input through the user interface. For example, the processor 420 may change location information of at least one neighboring electronic device based on a user input through the user interface. The processor 420 may transmit the changed information of the at least one neighboring electronic device to the server 406.

According to various embodiments, the processor 420 may include the data model as shown in FIG. 3, and may remotely control at least one neighboring electronic device 402, 404. For example, the processor 420 may remotely control the at least one neighboring electronic device 402, 404, based on the data model as shown in FIG. 3.

According to various embodiments, the processor 420 may detect a content playing event and/or a content sharing event, and, in response to this, may request the server 406 to transmit recommendation convergence configuration information for playing a content. For example, when an event for playing a first content through a first application is detected, the processor 420 may request the server 406 to transmit recommendation convergence configuration information for playing the content by transmitting information regarding the selected first content to the server 406. The first application may be an application that has a function of sharing a content with a neighboring electronic device and playing the content. In another example, when an event for sharing the first content with a neighboring electronic device and playing the first content is detected, the processor 420 may request the server 406 to transmit recommendation convergence configuration information for playing the content by transmitting the information regarding the first content to the server 406. When a neighboring electronic device with which the content is shared is determined based on a user input, the processor 420 may transmit information regarding the determined neighboring electronic device to the server 406 along with the information regarding the first content.

According to various embodiments, the processor 420 may receive the recommendation convergence configuration information from the server 220. The recommendation convergence configuration information may include, for example, at least one of information of a content output device and information of an environment creation device. According to an embodiment, the processor 420 may display the recommendation convergence configuration information on the screen. For example, the processor 420 may display at least one of the information of the environment creation device and the information of the content output device on the screen. According to an embodiment, the information of the environment creation device displayed on the screen may include at least one of identification information of the environment creation device, an icon, a sign, a product name, a device type, a current operation mode, user information corresponding to the current operation mode, a network connection state, and a recommendation operation mode. The user information corresponding to the current operation mode refers to information of a user who instructs the environment creation device to operate in the current operation mode, and may include at least one of identification information (for example, account information, a name, a nickname, sex, a phone number, etc.) of the corresponding user, priority information of the corresponding user, identification information of an electronic device related to the corresponding user, and priority information of the electronic device related to the corresponding user. The priority information may be indicated by, for example, a color, a sign, an icon, a text, a font type, a font size, or a combination thereof. According to an embodiment, the processor 420 may control an activation state of a setting item for setting the operation mode of the environment creation device, based on the priority of the user corresponding to the current operation mode of the environment creation device and/or the priority of the electronic device related to the user corresponding to the current operation mode. For example, when the priority of the user corresponding to the current operation mode of the environment creation device is higher than the priority of the user of the electronic device 401, or the priority of the electronic device related to the user corresponding to the current operation mode of the environment creation device is higher than the priority of the user of the electronic device 401, the processor 420 may inactivate the setting item for setting the operation mode of the environment creation device, and may display the setting item in the inactivated state. For example, the processor 420 may prevent the operation mode of the corresponding environment creation device from being changed by a user input, by inactivating the setting item for setting the operation mode of the environment creation device. According to an embodiment, the processor 420 may activate and display the setting item for setting the operation mode of the corresponding environment creation device, without considering the priority of the user corresponding to the current operation mode of the environment creation device and/or the priority of the electronic device related to the user corresponding to the current operation mode. For example, the processor 420 may control the operation mode of the environment creation device to be determined by a user input, by activating the setting item for setting the operation mode of the environment creation device.

According to an embodiment, the information of the content output device displayed on the screen may include at least one of identification information of the content output device, an icon, a sign, a product name, a device type, information on whether the device is used by another user, and a network connection state. According to an embodiment, when the content output device is used by another user, the information of the content output device displayed on the screen may include at least one of priority information of another user, identification information (for example, account information, a name, a nickname, sex, a phone number, etc.) of another user who is using the device, and priority information of another electronic device related to another user. The priority information may be indicated by, for example, a color, a sign, an icon, a text, a font type, a font size, or a combination thereof. According to an embodiment, the processor 420 may control at least one of whether the corresponding content output device is displayed on the screen, an activation state of a setting item of the content output device, and an on/off state of the setting item of the content output device, based on the priority of another user who is using the content output device, and/or the priority of another electronic device related to another user. For example, when the priority of another user using the content output device is higher than the priority of the user of the electronic device 401, or the priority of another electronic device related to another user using the content output device is higher than the priority of the electronic device 401, the processor 420 may not display the corresponding content output device on the screen. In another example, when the priority of another user using the content output device is higher than the priority of the user of the electronic device 401, or the priority of another electronic device related to another user using the content output device is higher than the priority of the electronic device 401, the processor 420 may inactivate a setting item for setting whether to use the corresponding output device, and may display the setting item in the inactivated state. For example, the processor 420 may prevent the corresponding content output device from being selected by a user input, by inactivating the setting item of the content output device. In still another example, when the priority of another user using the content output device is higher than the priority of the user of the electronic device 401, or when the priority of another electronic device related to another user using the content output device is higher than the priority of the electronic device 401, the processor 420 may set the setting item for setting whether to use the corresponding content output device to an Off state, and may display the setting item in the Off state. In yet another example, when the priority of another user using the content output device is lower or equal to the priority of the user of the electronic device 401, or the priority of another electronic device related to another user using the content output device is lower than or equal to the priority of the electronic device 401, the processor 420 may set the setting item for setting whether to use the corresponding content output device (or whether to share a content) to an On state, and may display the setting item in the On state.

According to an embodiment, the processor 420 may identify whether each content output device included in the recommendation convergence configuration information is near to the electronic device. For example, the processor 420 may identify whether each content output device included in the recommendation convergence configuration information is physically near to the electronic device 401, by using a signal using short-range wireless communication or a sound signal of a non-audible band. For example, the processor 420 may determine whether each content output device is near to the electronic device 401 by using a signal using wireless fidelity (Wi-Fi), light fidelity (LiFi), Bluetooth (BT), Bluetooth low energy (BLE), Zigbee, or infrared (IR) sensor, or a signal of a non-audible band through a microphone/speaker. When there is a content output device that is not near to the electronic device 401 from among the content output devices included in the recommendation convergence configuration information, the processor 420 may not display the content output device that is not near to the electronic device 401 on the screen. For example, the processor 420 may display, on the screen, only the content output devices which are identified as being near to the electronic device 401 from among the content output devices included in the recommendation convergence configuration information.

According to an embodiment, the processor 420 may display a screen interface for setting details related to the operation mode of the environment creation device and/or the content output device based on a user input. According to an embodiment, the screen interface for setting details may include at least one detail item, a current operation mode of the detail item, a recommendation operation mode of the detail item, setting-related information regarding the detail item, or a combination thereof. The setting-related information regarding the detail item may be information indicating whether the detail item is activated or not, information indicating an on/off state of the detail item, or a combination thereof. For example, the screen interface for setting details may include, as the detail item, an item for setting power on/off, an item for setting an operation mode in the power on state, and an item for setting whether to restore to the current operation mode after playing of the content is ended, and may include setting-related information regarding each item. According to an embodiment, the power on/off setting item and the operation mode setting item of the screen interface for setting details may be set to indicate a current operation mode, a recommendation operation mode set as default, a recommendation operation mode based on a using history, or a recommendation operation mode designated by the user. According to an embodiment, at least a portion of the at least one detail item, the recommendation operation mode regarding the detail item, and the setting-related information regarding the detail item, which are included in the screen interface for setting details, may be determined based on content information, a convergence configuration designated by the user, a using history, real-time states of neighboring electronic devices, a location of the electronic device, locations of the neighboring electronic devices, time, surrounding environment information, or a combination thereof.

According to various embodiments, the processor 420 may perform a function of taking over authority to use the content output device (or authority to output the content) from another user, based on a user input. According to an embodiment, the processor 420 may transmit a signal informing that the corresponding output device will be used to the electronic device of another user. The electronic device of another user may refer to another electronic device related to another user account. According to an embodiment, the processor 420 may transmit a signal for requesting the electronic device of another user to assign the authority to use the corresponding output device. The processor 420 may transmit an assignment request signal to the electronic device of another user through the server 406, or may directly transmit the assignment request signal to the electronic device of another user. According to an embodiment, the processor 420 may wait until use of the content output device by another user is ended by a user input, and may perform a function of using the corresponding content output device. For example, the processor 420 may request the server 406 or the electronic device of another user to notify the end of the use when the use of the content output device is ended. The processor 420 may share and play a content by using the corresponding content output device when the end of the use of the content output device is notified by the server 406 or the electronic device of another user. According to an embodiment, the processor 420 may perform the above-described function of taking over the authority to use the content output device, based on the priority of the user of the electronic device 401 and priority of another user using the content output device. According to an embodiment, the processor 420 may perform the above-described function of taking over the authority to use the content output device, based on the priority of the electronic device 401 and the priority of another electronic device corresponding to another user using the content output device.

According to an embodiment, the processor 420 may set an operation mode of the environment creation device and/or whether to use the content output device, based on a user input, and may transmit setting information regarding the operation mode of the environment creation device and/or regarding whether the content output device is used to the server 406. According to an embodiment, the processor 420 may transmit a control signal to at least one neighboring electronic device, based on the setting information regarding the operation mode of the environment creation device and/or regarding whether the content output device is used. For example, when the setting information regarding the operation mode of the environment creation device indicates “Air purifier: speed-low,” the processor 420 may directly transmit a signal for controlling the speed of the air purifier to be a low speed to the corresponding air purifier, or may transmit the signal to the server 406. In another example, when the setting information regarding whether the content output device is used indicates “First speaker: Use, Second speaker: Non-use, TV: Use,” the processor 420 may directly transmit a signal for requesting short-range wireless communication connection to the first speaker and the TV, or may transmit a connection request signal for the first speaker and the TV to the server 406. According to an embodiment, the processor 420 may transmit at least a portion of the content to the content output device communication connected, and may control the corresponding content output device to output data related to the content. According to an embodiment, the processor 420 may detect a content playing end event, and may transmit a content playing end signal to the server 406.

The memory 430 may include a volatile memory and/or nonvolatile memory. The memory 430 may store commands or data associated with at least one other element(s) of the electronic device 401. According to an embodiment, the memory 430 may store software and/or a program 440. The program 440 may include, for example, a kernel 441, a middleware 443, an application programming interface (API) 445, or an application program (or an application) 447. At least a portion of the kernel 441, the middleware 443, or the API 445 may be called an “operating system (OS).” According to an embodiment, the memory 430 may store the data model as shown in FIG. 3. According to an embodiment, the memory 430 may store user account information and profile information of the electronic device 401.

The kernel 441 may control or manage system resources (for example, the bus 410, the processor 420, the memory 430, and the like) that are used to execute operations or functions of other programs (for example, the middleware 443, the API 445, or the application program 447). Furthermore, the kernel 441 may provide an interface that allows the middleware 443, the API 445, or the application program 447 to access discrete elements of the electronic device 401 so as to control or manage system resources.

The middleware 443 may perform a mediation role such that the API 445 or the application program 447 communicates with the kernel 441 to exchange data. Furthermore, the middleware 443 may process one or more task requests received from the application program 447 according to a priority. For example, the middleware 443 may assign the priority, which makes it possible to use a system resource (for example, the bus 410, the processor 420, the memory 430, or the like) of the electronic device 401, to at least one of the application program 447, and may process the one or more task requests. The API 445 may be an interface through which the application 447 controls a function provided by the kernel 441 or the middleware 443, and may include, for example, at least one interface or function (for example, an instruction) for a file control, a window control, image processing, a character control, or the like.

The input/output interface 450 may perform a role of an interface of transmitting a command or data, input from a user or another external device, to other element(s) of the electronic device 401. Furthermore, the input/output interface 450 may output a command or data, received from other element(s) of the electronic device 401, to a user or an external electronic device. According to an embodiment, the input/output interface 450 may include a key pad, a dome switch, a physical button, a touch panel, and a jog & shuttle.

The display 460 may include, for example, a liquid crystal display (LCD), a light-emitting diode (LED) display, an organic LED (OLED) display, a microelectromechanical systems (MEMS) display, or an electronic paper display, or the like. The display 460 may display, for example, various contents (for example, a text, an image, a video, an icon, and/or a symbol) to a user. The display 460 may include a touch screen and may receive, for example, a touch, gesture, proximity, or hovering input using an electronic pen or a portion of a user's body. The display 460 may display recommendation convergence configuration information under control of the processor 420.

The communication interface 470 may establish communication between the electronic device 401 and an external device (for example, an electronic device 402, an electronic device 404, and the server 406). For example, the communication interface 470 may be connected to a network 462 through wireless communication or wired communication to communicate with the external device (for example, the electronic device 404 or the server 406). In another example, the communication interface 470 may be directly connected through wireless communication or wired communication 464 to communicate with the external device (for example, the electronic device 402). The communication interface 470 may transmit and receive a signal for making a call to another electronic device (for example, the electronic device 404, the server 406). The communication interface 470 may transmit and receive a signal for obtaining dynamic call information from the server 406 under control of the processor 420. The wireless communication may include cellular communication using at least one of, for example, long-term evolution (LTE), LTE advanced (LTE-A), code division multiple access (CDMA), wideband CDMA (WCDMA), universal mobile telecommunications system (UMTS), wireless broadband (WiBro), global system for mobile communications (GSM), or a fifth generation (5G) network. According to an embodiment, the wireless communication may include at least one (for example, short-rage communication) of Wi-Fi, LiFi, BT, BLE, Zigbee, near field communication (NFC), magnetic secure transmission (MST), radio frequency (RF), or a body area network (BAN). According to an embodiment, the wireless communication may include global navigation satellite system (GNSS). The GNSS may include, for example, global positioning system (GPS), global navigation satellite system (Glonass), Beidou navigation satellite system (Beidou) or Galileo (the European global satellite-based navigation system). Hereinafter, “GPS” and “GNSS” may be interchangeably used in the disclosure. The wired communication may include at least one of, for example, a universal serial bus (USB), a high-definition multimedia interface (HDMI), a recommended standard-232 (RS-232), power line communication, optical communication, or a plain old telephone service (POTS). The network 462 may include at least one of telecommunications networks, for example, a computer network (for example, local area network (LAN) or wide area network (WAN)), an internet, or a telephone network.

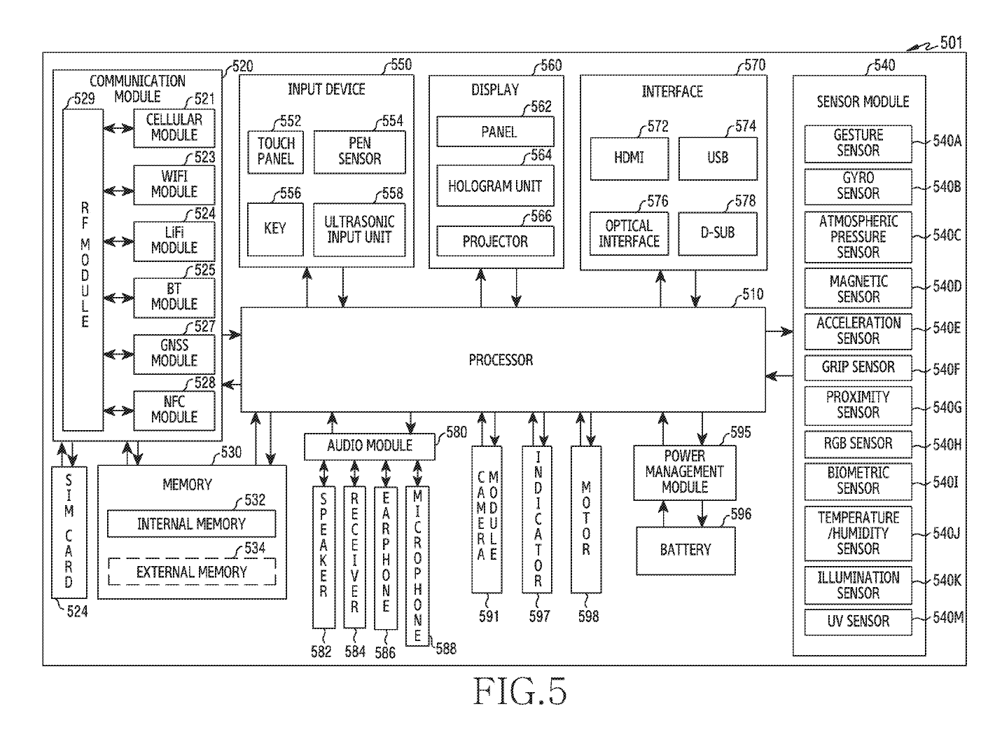

FIG. 5 is a block diagram illustrating an electronic device according to various embodiments of the disclosure. The electronic device 501 of FIG. 5 may include, for example, all or a portion of the electronic device 401 illustrated in FIG. 4.

Referring to FIG. 5, the electronic device 501 may include one or more processors 510 (for example, an AP), a communication module 520, a subscriber identification module 524, a memory 530, a sensor module 540, an input device 550, a display 560, an interface 570, an audio module 580, a camera module 591, a power management module 595, a battery 596, an indicator 597, and a motor 598.

The processor 510 may drive an OS or an application program to control a plurality of hardware or software elements connected to the processor 510, and may process and compute a variety of data. The processor 510 may be implemented with a system on chip (SoC), for example. According to an embodiment, the processor 510 may further include a graphics processing unit (GPU) and/or an ISP. The processor 510 may load and process a command or data, which is received from at least one of the other elements (for example, a nonvolatile memory), at a volatile memory, and may store resulting data at a nonvolatile memory.

According to an embodiment, the processor 510 may control a function of controlling an operation mode of at least one environment creation device positioned in the proximity of the electronic device 501 when playing a content. According to an embodiment, when playing a content, the processor 510 may control a function of connecting communication with at least one content output device positioned in the proximity of the electronic device 501, and of sharing the content with the at least one content output device communication-connected and playing the content.

The communication module 520 may be configured the same as or similar to the communication interface 470 of FIG. 4. The communication module 520 may include, for example, a cellular module 521, a Wi-Fi module 523, a LiFi module 524, a BT module 525, a GNSS module 527, an NFC module 528, and an RF module 529.

The cellular module 521 may provide, for example, voice communication, video communication, a messaging service, an Internet service or the like through a communication network. According to an embodiment, the cellular module 521 may perform discrimination and authentication of the electronic device 501 within a communication network using the subscriber identification module 524 (for example, a subscriber identification module (SIM) card). According to an embodiment, the cellular module 521 may perform at least a portion of functions that the processor 510 provides. According to an embodiment, the cellular module 521 may include a CP.

According to an example embodiment, at least a portion (for example, two or more) of the cellular module 521, the Wi-Fi module 523, the LiFi module 524, the BT module 525, the GNSS module 527, or the NFC module 527 may be included within one integrated chip (IC) or an IC package.

The RF module 529 may transmit and receive a communication signal (for example, an RF signal). The RF module 529 may include a transceiver, a power amplifier module (PAM), a frequency filter, a low noise amplifier (LNA), an antenna, or the like. According to another embodiment, at least one of the cellular module 521, the Wi-Fi module 523, the LiFi module 524, the BT module 525, the GNSS module 526, or the NFC module 527 may transmit and receive an RF signal through a separate RF module. The subscriber identification module 524 may include, for example, a card or an embedded SIM including a subscriber identification module, and may include unique identification information (for example, an integrated circuit card identifier (ICCID)) or subscriber information (for example, integrated mobile subscriber identity (IMSI)).

The memory 530 (for example, the memory 430 of FIG. 4) may include an internal memory 532 or an external memory 534. For example, the internal memory 532 may include at least one of a volatile memory (for example, a dynamic random access memory (DRAM), a static RAM (SRAM), or a synchronous DRAM (SDRAM)), and a nonvolatile memory (for example, a one-time programmable read only memory (OTPROM), a programmable ROM (PROM), an erasable and programmable ROM (EPROM), an electrically erasable and programmable ROM (EEPROM), a mask ROM, a flash ROM, a flash memory, a hard drive, or a solid state drive (SSD)). The external memory 534 may include a flash drive, for example, compact flash (CF), secure digital (SD), micro-SD, mini-SD, extreme digital (xD), multimedia card (MMC), a memory stick, or the like. The external memory 534 may be functionally or physically connected to the electronic device 501 through various interfaces.

The sensor module 540 may measure, for example, a physical quantity or may detect an operation state of the electronic device 501, and may convert the measured or detected information to an electrical signal. The sensor module 540 may include at least one of, for example, a gesture sensor 540A, a gyro sensor 540B, an atmospheric pressure sensor 540C, a magnetic sensor 540D, an acceleration sensor 540E, a grip sensor 540F, a proximity sensor 540G, a color sensor 540H (for example, a red, green, blue (RGB) sensor), a biometric sensor 540I, a temperature/humidity sensor 540J, an illuminance sensor 540K, or an ultraviolet (UV) sensor 540M. For example, the sensor module 540 may include, for example, an E-nose sensor, an electromyography sensor (EMG) sensor, an electroencephalogram (EEG) sensor, an electrocardiogram (ECG) sensor, an IR sensor, an iris sensor, and/or a fingerprint sensor. The sensor module 540 may further include a control circuit for controlling at least one sensor included therein. According to an embodiment, the electronic device 501 may further include a processor which is a portion of the processor 510 or a separate element from the processor 510 and is configured to control the sensor module 240. The processor 510 may control the sensor module 240 while the processor 210 remains at a sleep state. For example, the temperature/humidity sensor 540J may include a plurality of temperature sensors disposed at different positions.

The input device 550 may include a touch panel 552, a (digital) pen sensor 554, a key 556, or an ultrasonic input device 558. The touch panel 552 may use at least one of a capacitive, resistive, IR or ultrasonic detecting method. Also, the touch panel 552 may further include a control circuit. The touch panel 552 may further include a tactile layer to provide a tactile reaction to a user. The (digital) pen sensor 554 may be, for example, a portion of a touch panel or may include an additional sheet for recognition. The key 556 may include, for example, a physical button, an optical key, or a keypad. The ultrasonic input device 558 may detect an ultrasonic wave, which is generated from an input tool, through a microphone (for example, a microphone 588), and may identify data corresponding to the detected ultrasonic wave.

The display 560 (for example, the display 460 of FIG. 4) may include a panel 562, a hologram device 564, a projector 566, and/or a control circuit for controlling the aforementioned elements. The panel 562 may be implemented to be flexible, transparent, or wearable. The panel 562 and the touch panel 552 may be integrated into one or more modules. The hologram device 564 may display a stereoscopic image in a space using a light interference phenomenon. The projector 566 may project light onto a screen so as to display an image. The screen may be disposed inside or outside the electronic device 501. The interface 570 may include an HDMI 572, a USB 574, an optical interface 576, or a D-subminiature (D-sub) 578. The interface 570 may be included, for example, in the communication interface 270 illustrated in FIG. 2. For example, the interface 570 may include, for example, a mobile high definition link (MHL) interface, an SD card/MMC interface, or an infrared data association (IrDA) standard interface.

The audio module 580 may convert a sound and an electric signal in dual directions. At least a portion of the audio module 580 may be included, for example, in the input/output interface 450 illustrated in FIG. 4. The audio module 580 may process, for example, sound information that is inputted or outputted through a speaker 582, a receiver 584, an earphone 586, or a microphone 588.

The camera module 591 may be, for example, a device for shooting a still image or a video, and according to an embodiment, the camera module 591 may include, for example, one or more image sensors (for example, a front sensor or a rear sensor), a lens, an ISP, or a flash (for example, an LED or a xenon lamp).

The power management module 595 may manage, for example, power of the electronic device 501. The power management module 595 may include a power management integrated circuit (PMIC), a charger IC, or a battery or fuel gauge. The PMIC may have a wired charging method and/or a wireless charging method. The wireless charging method may include, for example, a magnetic resonance method, a magnetic induction method or an electromagnetic wave method. The PMIC may further include an additional circuit for wirelessly charging, for example, a coil loop, a resonance circuit, or a rectifier, and the like. The battery gauge may measure, for example, a remaining capacity of the battery 596 and a voltage, current or temperature thereof while the battery is charged. The battery 596 may include, for example, a rechargeable battery and/or a solar battery.

The indicator 597 may display a specific state of the electronic device 501 or a portion thereof (for example, the processor 510), such as a booting state, a message state, a charging state, and the like. The motor 598 may convert an electrical signal into a mechanical vibration and may generate vibration, a haptic effect, and the like. For example, the electronic device 501 may include a mobile TV supporting device (for example, a GPU) for processing media data according to the standards of digital multimedia broadcasting (DMB), digital video broadcasting (DVB), MediaFlo™, or the like.

Each of the elements described in the disclosure may be configured with one or more components, and the names of the elements may be changed according to the type of the electronic device. According to various embodiments, some elements of the electronic device (for example, the electronic device 501) may be omitted or other additional elements may be added. Furthermore, some of the elements may be combined with each other so as to form one entity, and the functions of the elements may be performed in the same manner as before being combined.

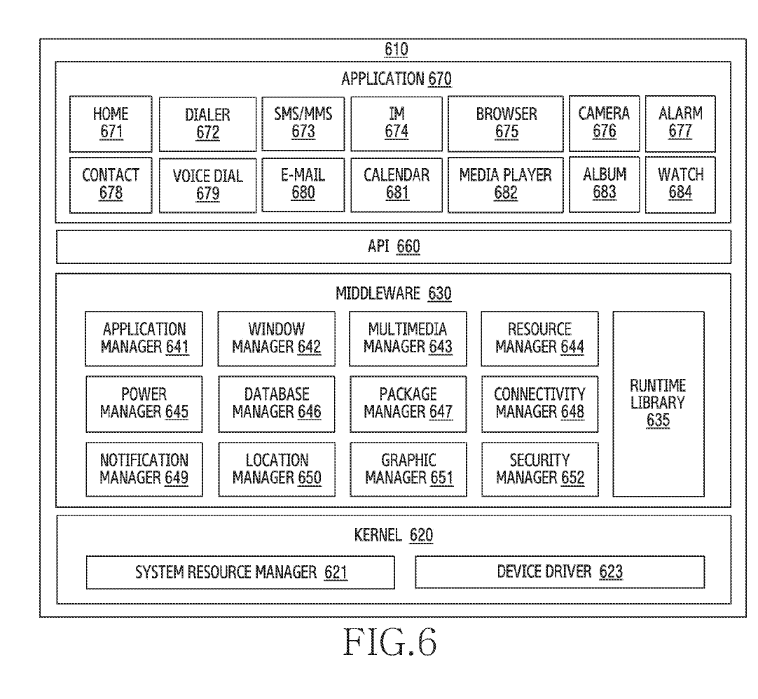

FIG. 6 is a block diagram illustrating a program module according to various embodiments of the disclosure. According to an embodiment, the program module 610 (for example, the program 440) may include an OS to control resources of an electronic device (for example, the electronic device 401), and/or various applications (for example, the application program 447) executable in the OS. The OS may include, for example, Android™, iOS™, Windows™, Symbian™, Tizen™, or Bada™.

Referring to FIG. 6, the program module 610 may include a kernel 620 (for example, the kernel 441), middleware 630 (for example, the middleware 443), an API 660 (for example, the API 445), and/or an application 670 (for example, the application program 447). At least a portion of the program module 610 may be pre-loaded on the electronic device, or may be downloaded from an external electronic device (e.g., the electronic device 402, 404 or the server 406).

The kernel 620 may include, for example, a system resource manager 621 and/or a device driver 523. The system resource manager 621 may control, allocate or collect the system resources. According to an embodiment, the system resource manager 621 may include a process manager, a memory manager, or a file system manager. The device driver 623 may include, for example, a display driver, a camera driver, a BT driver, a shared memory driver, a USB driver, a keypad driver, a Wi-Fi driver, an audio driver, a touch device driver, a pressure device driver, or an inter-process communication (IPC) driver.

The middleware 630 may provide functions which are commonly used by the application 670 or may provide various functions to the application 670 through the API 660, such that the application 670 can use limited system resources in the electronic device. According to an embodiment, the middleware 630 may include at least one of a runtime library 635, an application manager 641, a window manager 642, a multimedia manager 643, a resource manager 644, a power manager 645, a database manager 646, a package manager 647, a connectivity manager 648, a notification manager 649, a location manager 650, a graphic manager 651, or a security manager 652.

For example, the runtime library 635 may include a library module which is used by a compiler to add a new function through a programming language while the application 670 is executed. The runtime library 635 may perform input/output management, memory management, or an arithmetic function. The application manager 641, for example, may manage the life cycle of the application 670. According to an embodiment, the application manager 641 may transmit a biometric information request signal to the security manager 652 based on a content request of the application 670. The application manager 641 may provide content information provided by the database manager 646 to the application 670. The window manager 642 may manage GUI resources used on a screen. The multimedia manager 643 may identify a format to be used to play media files, and may encode or decode a media file using a codec appropriate for a corresponding format. The multimedia manager 643 may control a function of sharing a media file with another electronic device and of playing the shared media file. The resource manager 644 may manage the source code of the application 670 or a memory space of the memory. The power manager 645, for example, may manage the capacity or power of a battery, and provide power information necessary for the operation of the electronic device. According to an embodiment, the power manager 645 may interwork with a basic input/output system (BIOS). The database manager 646 may generate, search, or change a database to be used by the application 670. According to an embodiment, the database manager 646 may search the database and detect a content matching biometric information provided by the security manager 652. The package manager 647 may manage installation or update of an application that is distributed in the form of a package file. The connectivity manager 648, for example, may manage a wireless connection. The notification manager 649, for example, may provide an event such as a received message, appointment, notification of proximity to a user. The location manager 650, for example, may manage locational information of the electronic device. The graphic manager 651, for example, may manage graphic effects to be offered to a user or a user interface related to the graphic effects. The security manager 652, for example, may provide system security or user authentication. According to an embodiment, the security manager 652 may collect biometric information through the biometric sensor 5401 based on a biometric information request signal provided from the application manager 641.

According to an embodiment, the middleware 630 may include a telephony manager to manage a speech or video telephony function of the electronic device, or a middleware module to form a combination of the various functions of the above-described elements. According to an embodiment, the middleware 630 may provide a module which is customized according to a kind of an OS. The middleware 630 may dynamically delete a portion of the existing elements or may add new elements. The API 660 may be, for example, a set of API programming functions and may be provided as a different configuration according to an OS. For example, in the case of Android or iOS, a single API set may be provided for each platform. In the case of Tizen, two or more API sets may be provided for each platform.

The application 670 may include, for example, home 671, dialer 672, short message service (SMS)/multimedia messaging service (MMS) 673, instant message (IM) 674, browser 675, camera 676, alarm 677, contact 678, voice dial 679, email 680, calendar 681, media player 682, album 683, watch 684, call, health care (e.g., for measuring the degree of workout or blood sugar), or environmental information (e.g., for measuring air pressure, humidity, or temperature information) providing application. According to an embodiment, the application 670 may further include an information exchanging application that is capable of supporting information exchange between the electronic device and the external electronic device. The information exchange application, for example, may include a notification relay application adapted to transfer specific information to the external electronic device or a device management application adapted to manage the external electronic device. For example, the notification relay application may transfer notification information occurring at another application of the electronic device to the external electronic device, or may receive notification information from the external electronic device and provide the notification information to a user. The device management application may control the function (e.g., turn-on or turn-off of the external electronic device (or some components), or adjustment of brightness (or resolution) of the display) of the external electronic device communicating with the electronic device, and may install, delete, or update an application running on the external electronic device. According to an embodiment, the application 670 may include an application (for example, a health care application of a mobile medical device) which is assigned in accordance with an attribute of the external electronic device. According to an embodiment, the application 670 may include an application which is received from the external electronic device. According to an embodiment, the application 670 may include an application providing a user authentication service. The application providing the user authentication service may include, for example, applications that should perform user authentication to execute a function requested by the user, such as an application providing a locking function, an application providing a payment function, etc. At least a portion of the program module 310 may be implemented (for example, executed) by software, firmware, hardware (for example, the processor 210), or a combination of two or more thereof, and may include modules, programs, routines, sets of instructions, or processes for performing one or more functions.

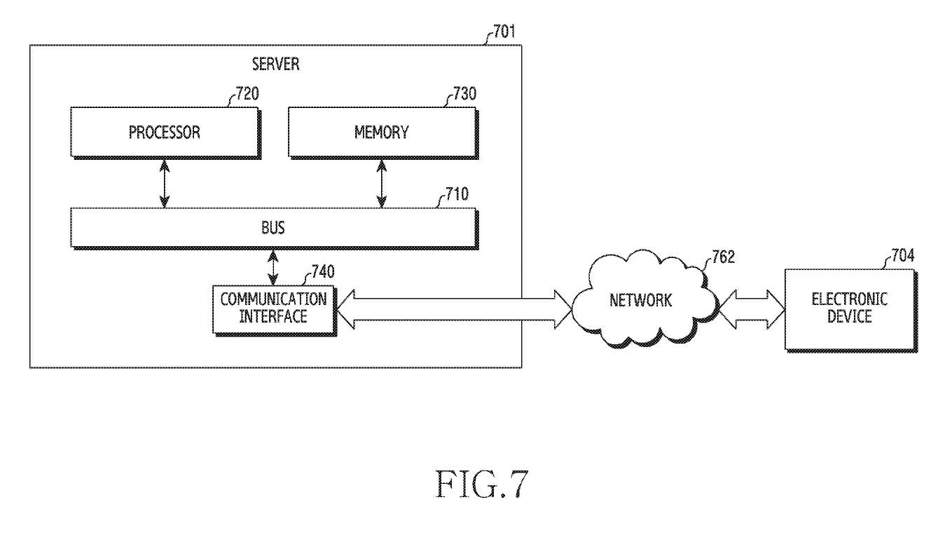

FIG. 7 is a block diagram illustrating a server in a network environment according to various embodiments of the disclosure. The server 701 of FIG. 7 may be the server 120 illustrated in FIG. 1 and/or the server 220 illustrated in FIG. 2.

Referring to FIG. 7, the server 701 may include a bus 710, a processor 720, a memory 730, and a communication interface 740. According to an embodiment, the server 701 may omit at least one of the elements or may further include other element(s).

The bus 710 may interconnect the above-described elements 720-740 and may include a circuit for transmitting communications (for example, a control message and/or data) among the above-described elements.

The processor 720 may include one or more of a CPU or a CP. The processor 720 may perform, for example, an operation or data processing associated with control and/or communication of at least one other element(s) of the server 701.

According to various embodiments, the processor 720 may store and manage user account information and profile information regarding at least one electronic device (for example, an electronic device 704). The processor 720 may map information of the electronic device having the user account information registered onto the corresponding user account information, and may manage the mapped information. The processor 720 may obtain and store at least one piece of location information related to each user account, based on location information received from at least one electronic device (for example, the electronic device 704). The processor 720 may identify neighboring electronic devices related to the user account, based on a signal received from the at least one electronic device (for example, the electronic device 704). According to an embodiment, the processor 720 may generate and store the data model as shown in FIG. 3, based on a signal received from the at least one electronic device (for example, the electronic device 704). For example, the processor 720 may manage and control neighboring electronic devices corresponding to at least one location (for example, home, office, institute, etc.) according to each user account. The processor 720 may manage at least one piece of location information related to the user account, and may group the neighboring electronic devices corresponding to each location information into at least one group, and manage the group. For example, the processor 720 may group neighboring electronic devices corresponding to a home position of a first user account into the same group as that of a main room, a living room, or speakers, and may manage the group. According to various embodiments, the processor 720 may generate and manage a routine to control actions and events of the neighboring electronic devices related to the user account.

According to various embodiments, the processor 720 may receive state information from the neighboring electronic devices registered at the server 701. The state information may periodically received, or may be received every time the state information is changed or when a specific event occurs. For example, the processor 720 may receive, from the neighboring electronic devices, state messages which are classified as shown in table 1, and may store and change the state information of the neighboring electronic devices based on the received state messages.

According to various embodiments, the processor 720 may receive content information from the electronic device 704, and may generate recommendation convergence configuration information based on the received content information. According to an embodiment, the processor 720 may generate recommendation convergence configuration information based on at least one of a type of the content, metadata of the content, and attribute information of the content. Specifically, the processor 720 may pre-store a table for recommendation convergence configuration as shown in table 2 presented below, and may generate recommendation convergence configuration information according to pre-stored rules.

TABLE 2

| Content | Content | |
|---|---|---|
| type | attributes | Convergence configuration |
| Music | Channel (2.1, | Content output: smart phone + sound bar + |
| (sound | 5.1, etc.), | wireless speaker |
| only) | format | Content output: smart phone + wireless |
| | | speaker |
| | | Environment creation: Air purifier |
| | | Content output: smart phone + TV + sound |
| | | bar + wireless speaker |
| | | Content output: smart phone + refrigerator |
| | | (family hub) |
| | | Environment creation: Air conditioner |
| | | Content output: smart phone + PC + wireless |
| | | speaker |
| | | Environment creation: Robot cleaner |
| Photo, | Resolution, | Content output: smart phone + TV + sound |
| image | channel (2.1, | bar + speaker |
| (sound & | 5.1, etc.), | Environment creation: Curtain |
| video) | format | Content output: smart phone + refrigerator |
| | | (family hub) |
| | | Environment creation: Lighting device |
| Game | Resolution, | Content output: smart phone + TV + sound |
| (sound | channel (2.1, | bar + speaker |
| & video) | 5.1, etc.) | Environment creation: Robot cleaner |
| | | Content output: smart phone + TV |
| | | Environment creation: Curtain, lighting |
| | | device |
| Document | Orientation, | Content output: smart phone + TV + sound |
| (sound & | format | bar |
| video) | | Environment creation: Lighting device |
| | | Content output: smart phone + tablet |
| | | Content output: smart phone + PC |

For example, when the content type is music and the content attribute is channel 2.1, the processor 720 may select a smart phone, a PC, and a wireless speaker having an audio output function to output a content, and may select a robot cleaner related to a sound to create an environment. In another example, when the content type is a game and the content attribute is a resolution of 5.1, the processor 720 may select the smart phone and the TV having an image output function and/or an audio output function to output a content, and may select a curtain and a lighting device related to light to create an environment.

According to various embodiments, the processor 720 may generate recommendation convergence configuration information based on content information, a convergence configuration designated by the user, a using history, real-time states of neighboring electronic devices, a location of the electronic device, locations of the neighboring electronic devices, time, surrounding environment information, or a combination thereof. For example, the processor 720 may pre-receive a recommendation convergence configuration designated by a user input from the electronic device. The processor 720 may select a content output device and/or an environment creation device to play a content of the electronic device, based on the recommendation convergence configuration pre-designated by the user. In another example, the processor 720 may select a content output device and/or an environment creation device to play the content of the electronic device, based on a content output device connecting history and an environment creation device controlling history of the electronic device. In still another example, the processor 720 may select a content output device and/or an environment creation device to play the content of the electronic device, based on current states of the content output devices and the environment creation devices registered at the server 701. In yet another example, the processor 720 may select a content output device and/or an environment creation device to play the content of the electronic device by considering the location of the electronic device and the locations of the neighboring electronic devices. In further example, the processor 720 may select a content output device and/or an environment creation device to play the content of the electronic device based on current time information. For example, the processor 720 may select at least one environment creation device based on whether the current time is day time or night time. In still further example, the processor 720 may select a content output device and/or an environment creation device to play the content of the electronic device, based on surrounding environment information of the electronic device. The processor 720 may obtain surrounding environment information of the electronic device from at least one of the electronic device, the neighboring electronic devices of the electronic device, and other servers. The surrounding environment information may include, for example, information related to a surrounding environment of the electronic device, such as weather, temperature, fine dust, brightness, atmospheric pressure, wind speed, etc. According to an embodiment, the processor 720 may identify whether the selected content output device is used by another user electronic device, and may generate recommendation convergence configuration information based on whether the corresponding content output device is used by another user electronic device. For example, when the selected content output device is used by another user electronic device, the processor 720 may generate recommendation convergence configuration information including at least one of information indicating whether the corresponding content output device is used by another user, account information of another user, priority information of another user, identification information of another user electronic device, and priority information of another user electronic device. According to an embodiment, the processor 720 may generate recommendation convergence configuration information based on at least one of the priority of another user who is using the selected content output device, and the priority of another user electronic device. For example, when the sound bar, the wireless speaker, and the TV are selected to output the content of the electronic device related to the first user account, but another electronic device related to the second user account is using the TV, the processor 720 may determine whether to include the TV in the recommendation convergence configuration information, based on at least one of the priorities of the first user account and the second user account, and the priorities of the electronic device related to the first user account and another electronic device related to the second user account. For example, when the priority of the first user account is higher than or equal to the priority of the second user account or the priority of the electronic device related to the first user account is higher than or equal to the priority of another electronic device related to the second user account, the processor 720 may generate recommendation convergence configuration information indicating “Content output devices: sound bar, wireless speaker, and TV (occupied by the second user account).” In another example, when the priority of the first user account is lower than the priority of the second user account, or when the priority of the electronic device related to the first user account is lower than the priority of another electronic device related to the second user account, the processor 720 may exclude the TV which is being used by the second user account, and may generate recommendation convergence configuration information indicating “Content output devices: sound bar and wireless speaker.” According to an embodiment, the processor 720 may generate content configuration information including setting-related information regarding the selected content output device. The processor 720 may determine the setting-related information regarding the content output device, based on content information, a convergence configuration designated by the user, a using history, real-time states of neighboring electronic devices, a location of the electronic device, locations of the neighboring electronic devices, time, surrounding environment information, or a combination thereof. The setting-related information may be information regarding an item for setting whether the electronic device uses the corresponding content output device, and may be information indicating whether the setting item is activated, information indicating an on/off state of the setting item, or information indicating a combination thereof. For example, the processor 720 may generate information indicating “activated, on state” regarding the setting item of the sound bar, based on the recommendation convergence configuration pre-designated by the user. In another example, the processor 720 may generate information indicating “activated, on state” regarding the setting item of the sound bar, and indicating “activated, off state” regarding the setting item of the TV, based on a content output device connecting history of the electronic device. According to an embodiment, the processor 720 may generate recommendation convergence configuration information including a current operation mode of the selected environment creation device, user information corresponding to the current operation mode, a recommendation operation mode, setting-related information, information related to items to be included in a detail setting screen, or a combination thereof. The user information corresponding to the current operation mode may be information indicating a user who instructs the corresponding environment creation device to operate in the current operation mode. For example, when it is identified that the environment creation device is operated in the current operation mode according to an instruction from a specific user electronic device, the processor 720 may include information of the specific user instructing the current operation mode in the recommendation convergence configuration information. The recommendation operation mode may be a mode in which the environment creation device is controlled not to hinder playing of the content of the electronic device, or a mode which is set as default. The setting-related information may include information related to an item for setting whether the electronic device controls the corresponding environment creation device. For example, the setting-related information may be information indicating whether the setting item is activated, information indicating an on/off state of the setting item, or information indicating a combination thereof. The information related to the items to be included in the detail setting screen may include information indicating detail items to be included in the detail setting screen, current operation modes of the detail items, recommendation operation modes of the detail items, setting-related information regarding the detail items, or a combination thereof.

According to an embodiment, the processor 720 may determine at least one of a recommendation operation mode of the environment creation device, setting information of the environment creation device, information indicating detail items to be included in the detail setting screen, recommendation operation modes regarding the detail items, and setting-related information related to the detail items, based on content information, a convergence configuration designated by the user, a using history, real-time states of neighboring electronic devices, a location of the electronic device, locations of the neighboring electronic devices, time, surrounding environment information, or a combination thereof. For example, when a fine dust concentration, which is one piece of information of the surrounding environment information, is a value corresponding to “normal” (for example, 31-80 μg/m³), the processor 720 may determine the recommendation operation mode as “Fan speed: Low,” and, when the fine dust concentration is a value corresponding to “very bad” (for example, 151 μg/m³ or higher), the processor 720 may determine the recommendation operation mode as “Fan speed: high.” In another example, when there is a history of having controlled the operation mode of the air purifier for the sake of enjoying a content, as a result of identifying the using history of the electronic device, the processor 720 may determine the setting-related information regarding the setting item of the air purifier as “activated, on state,” and, when there is no history of having controlled the operation mode of the air purifier for the sake of enjoying the content, the processor 720 may determine the setting-related information regarding the setting item of the air purifier as “activated, off state.” In still another example, the processor 720 may obtain current time information, and when the current time is day time, the processor 720 may determine detail items to be included in the detail setting screen of the air purifier to be “a power on/off setting item, a fan speed setting item, an air volume setting item, a quick mode operation setting item, and an operation mode recovery setting item,” from among detail items which can be included in the detail setting screen of the air purifier, “a power on/off setting item, a fan speed setting item, an air volume setting item, a sleep mode setting item, a quick mode operation setting item, and an operation mode recovery setting item.” When the current time is night time, the processor 720 may determine the detail items to be included in the detail setting screen of the air purifier to be “the power on/off setting item, the fan speed setting item, the sleep mode setting item, and the operation mode recovery setting item.” In yet another example, the processor 720 may determine the recommendation operation mode and/or setting-related information regarding the detail items of the air purifier to be “power on/off setting item-activated, on state, fan speed setting item-auto, quick mode operation setting item-activated, off state, and operation mode recovery setting item-activated, on state,” based on the current item and the using history.

According to an embodiment, the processor 720 may determine at least one of the recommendation operation mode of the environment creation device, the setting information of the environment creation device, information indicating the detail items to be included in the detail setting screen, the recommendation operation modes regarding the detail items, and the setting-related information regarding the detail items, as a pre-set default value. The default value may be pre-set based on at least one of time, surrounding environment information, a content type, and a location of the electronic device. For example, the processor 720 may set the default value of the air purifier to “1. day time→recommendation operation mode-fan speed: high, setting information-activated, on state,” “2. night time→recommendation operation mode-fan speed: low, setting information-activated, on state.” In another example, the processor 720 may set the default value of the air purifier to “1. location of the electronic device: first location→recommendation operation mode-fan speed: high, setting information-activated, on state,” “2. location of the electronic device: second location→recommendation operation mode-fan speed: low, setting information-activated, off state.” According to various embodiments, the processor 720 may transmit, to the electronic device 704, the recommendation convergence configuration information including at least one of the content output device and the environment creation device. According to various embodiments, the processor 720 may receive, from the electronic device 704, a response signal regarding the recommendation convergence configuration information. The processor 720 may identify a content output device selected by the electronic device 704, based on the received response signal, and may transmit a control signal for connecting communication with the electronic device 704 to the identified content output device. The processor 720 may identify an operation mode of at least one environment creation device based on the received response signal, and may transmit a control signal based on the identified operation mode to the at least one environment creation device.

According to various embodiments, the processor 720 may detect a content playing end event of the electronic device 704, and may restore states of the content output device and the environment creation device related to playing of the content to previous states. For example, the processor 720 may store information related to the current states of the neighboring electronic devices, included in the recommendation convergence configuration information, when generating the recommendation convergence configuration information, and may restore the states of the corresponding neighboring electronic devices after playing of the content of the electronic device 704 is ended. The information related to the current state may include at least one of, for example, state information of the corresponding neighboring electronic device, log information regarding an application which is being executed, user account information, communication connection information, and task-related information. The state information may include a task performing situation, information on an error or a breakdown, an operation mode and a detail setting mode, an on/off state. etc.

The memory 730 may include a volatile memory and/or a nonvolatile memory. The memory 730 may store, for example, a command or data associated with at least one other element of the server 701. According to an embodiment, the memory 730 may store profile information regarding at least one electronic device (for example, the electronic device 704). According to an embodiment, the memory 730 may store identification information of an electronic device registered at the server 701, user account information of the electronic device, identification information of neighboring electronic devices, and state information of the neighboring electronic devices. The memory 730 may store electronic device information related to user account information, neighboring electronic devices related to user account information, and/or location information related to user account information. The memory 730 may store information related to a state of a neighboring electronic device corresponding to the time of generating the recommendation convergence configuration information. The information related to the state of the neighboring electronic device may include at least one of, for example, state information of the corresponding neighboring electronic device, log information of an application which is being executed at the corresponding neighboring electronic device, user account information related to the corresponding neighboring electronic device, communication connection information of the corresponding neighboring electronic device, and task-related information of the corresponding neighboring electronic device. The state information may include a task performing situation, information on an error and a breakdown, an operation mode and a detail setting mode, an on/off state, etc. The memory 730 may store using history information of the electronic device regarding the neighboring electronic devices. For example, the memory 730 may store, as the using history information, setting information regarding the content output device which is used to share the content with the electronic device, and setting information regarding an operation of the environment creation device controlled by the electronic device. The using history information may be obtained from the response signal to the transmission of the recommendation convergence configuration information. The memory 730 may store convergence configuration information pre-set by the user.

The communication interface 740 may establish communication between the server 701 and an external device (for example, the electronic device 704, a server 706). For example, the communication interface 740 may be connected to a network 762 via wireless communication or wired communication to communicate with the external device (for example, the electronic device 704, the server 706). The communication interface 740 may transmit and receive a signal for a call to and from another electronic device (for example, the electronic device 704). The communication interface 740 may transmit and receive a signal including dynamic call information to and from the electronic device 704 and/or the server 706 under control of the processor 720.

The wireless communication may include cellular communication using at least one of, for example, LTE, LTE-A, CDMA, WCDMA, UMTS, WiBro, GSM, or a 5G network. According to an embodiment, the wireless communication may include at least one (for example, short-rage communication) of Wi-Fi, LiFi, BT, BLE, Zigbee, NFC, MST, RF, or a BAN. According to an embodiment, the wireless communication may include GNSS. The GNSS may include, for example, GPS, Glonass, Beidou or Galileo (the European global satellite-based navigation system). Hereinafter, “GPS” and “GNSS” may be interchangeably used in the disclosure. The wired communication may include at least one of, for example, a USB, a HDMI, RS-232, power line communication, optical communication, or POTS. The network 762 may include at least one of telecommunications networks, for example, a computer network (for example, LAN or WAN), an internet, or a telephone network.

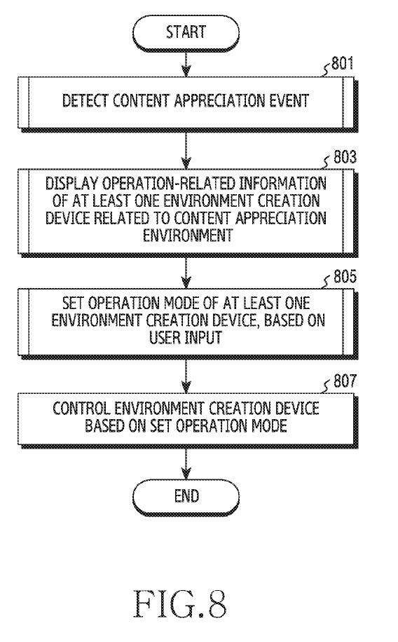

FIG. 8 is a view illustrating an operation procedure for controlling a neighboring electronic device when playing a content in an electronic device according to various embodiments of the disclosure. In embodiments described below, operations may be performed in sequence, but may not necessarily be performed in sequence. For example, the order of operations may be changed and at least two operations may be performed in parallel. Herein, the electronic device may be the electronic device 100 of FIG. 1, the electronic device 200 of FIG. 2, or the electronic device 401 of FIG. 4.

Referring to FIG. 8, the electronic device may detect a content appreciation event in operation 801. The content appreciation event may be a content playing event or a content sharing event. The content appreciation event may be detected by a user input.

In operation 803, the electronic device may display operation-related information of at least one environment creation device related to a content appreciation environment. According to an embodiment, the processor 420 may display, on the display 460, at least one of identification information, a current operation mode, and a recommendation operation mode of at least one environment creation device that influences the content appreciation environment, in response to the content appreciation event. The identification information of the at least one environment creation device may include at least one of an identifier (ID), an icon, a sign, a product name, a device type of the environment creation device. According to an embodiment, the processor 420 may additionally display, on the display 460, user information corresponding to the current operation mode of the environment creation device. The user information corresponding to the current operation mode refers to information of a user instructing the corresponding environment creation device to operate in the current operation mode, and may include at least one of identification information of the corresponding user (for example, account information, a name, a nickname, sex, a phone number, etc.), priority information of the corresponding user, identification information of an electronic device related to the corresponding user, and priority information of the electronic device related to the corresponding user. The priority information may be indicated by, for example, a color, a sign, an icon, a text, a font type, a font size, or a combination thereof.

In operation 805, the electronic device may set an operation mode of the at least one environment creation device, based on a user input. According to an embodiment, the processor 420 may set the at least one environment creation device to switch from the current operation mode to the recommendation operation mode, and to operate. According to an embodiment, the processor 420 may set the at least one environment creation device to be maintained in the current operation mode. According to an embodiment, the processor 420 may set the at least one environment creation device to switch to an operation mode set by a user input.

In operation 807, the electronic device may control the at least one environment creation device based on the set operation mode. According to an embodiment, the processor 420 may request the server to control the operation mode of the environment creation device, by controlling the communication interface 470 to transmit a signal including information of the operation mode set for the at least one environment creation device to the server. According to an embodiment, the processor 420 may generate a control signal regarding the at least one environment creation device based on the set operation mode, and may control the communication interface 470 to transmit the generated control signal to the corresponding environment creation device.

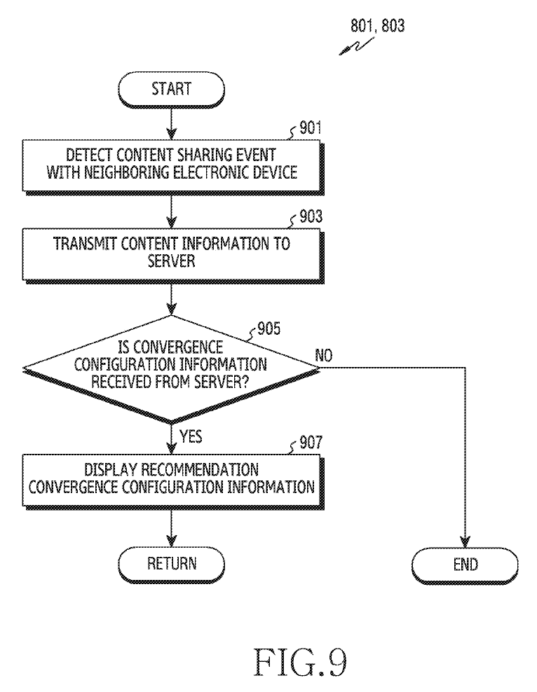

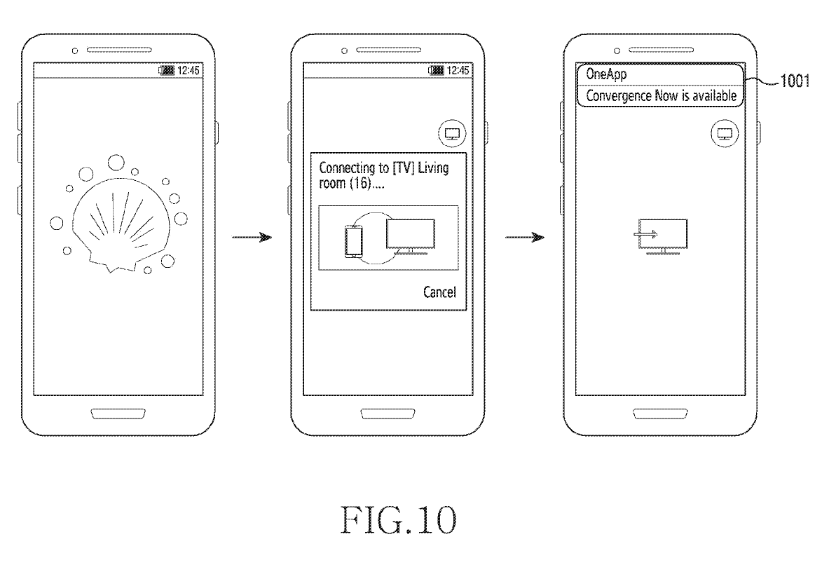

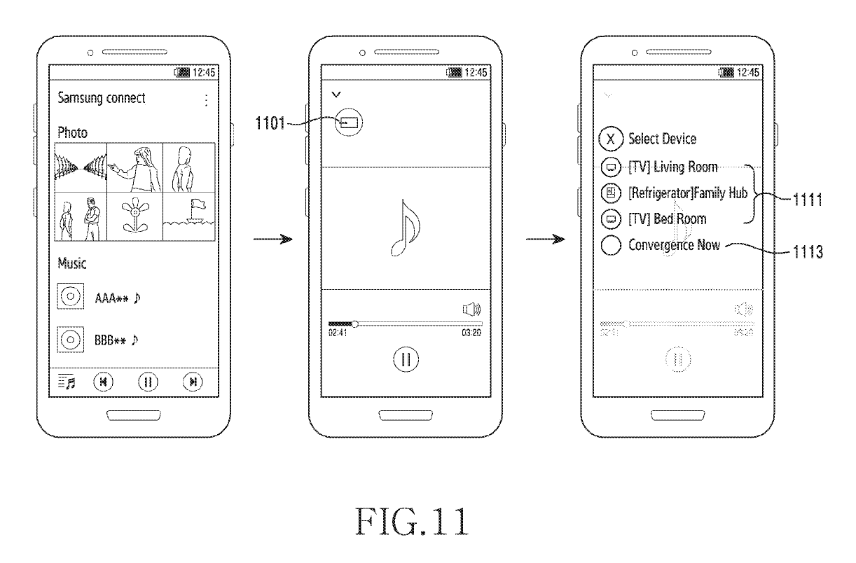

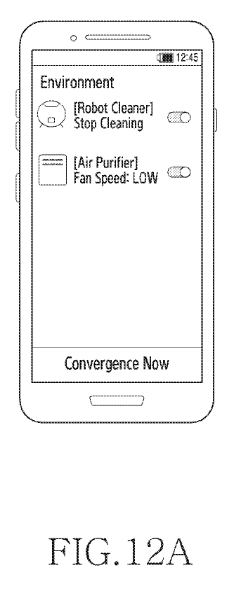

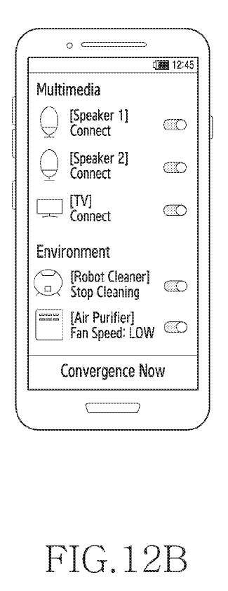

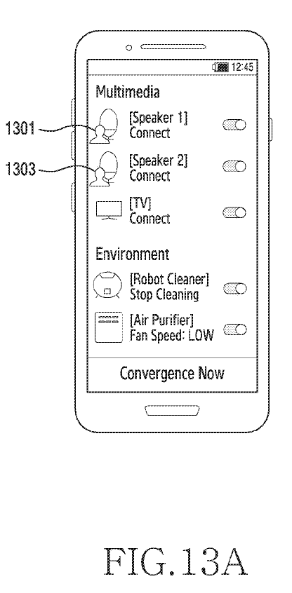

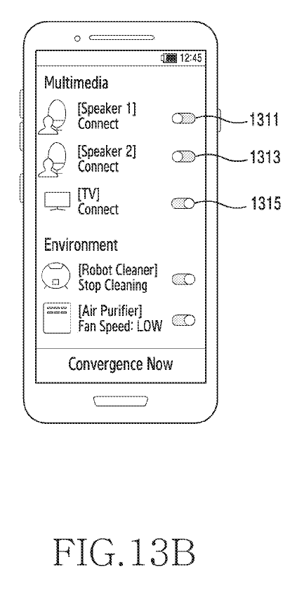

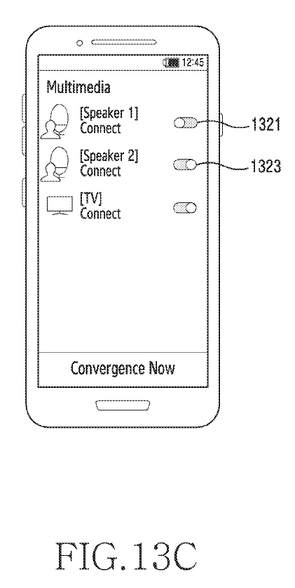

FIG. 9 is a view illustrating an operation procedure for displaying information regarding a neighboring electronic device in an electronic device according to various embodiments of the disclosure. Hereinafter, operations 801 and 803 of FIG. 8 will be described in detail. In embodiments described below, operations may be performed in sequence, but may not necessarily be performed in sequence. For example, the order of operations may be changed and at least two operations may be performed in parallel. Herein, the electronic device may be the electronic device 100 of FIG. 1, the electronic device 200 of FIG. 2, or the electronic device 401 of FIG. 4. Hereinafter, the operation procedure of FIG. 9 will be described with reference to FIGS. 10, 11, 12A, 12B, 13A, 13B and 13C. FIG. 10 illustrates a screen configuration for playing and sharing a content in an electronic device according to various embodiments of the disclosure. FIG. 11 illustrates a screen configuration for playing and sharing a content in an electronic device according to various embodiments of the disclosure. FIGS. 12A and 12B illustrate screen configurations displaying information regarding neighboring electronic devices in an electronic device according to various embodiments of the disclosure. FIGS. 13A and 13B illustrate screen configurations displaying information regarding whether neighboring electronic devices are used by other users in an electronic device according to various embodiments of the disclosure.

Referring to FIGS. 9, 10, 11, 12A, 12B, 13A, 13B, and 13C, the electronic device may detect a content sharing event with a neighboring electronic device in operation 901. The processor 420 may detect a content sharing event with a neighboring electronic device before or while playing a content. For example, the processor 420 may detect that an event for sharing a video content with a TV occurs, while playing the video content by executing a video application, as shown in FIG. 10. In another example, when it is detected that a content is selected by a user input while a first application having a function of sharing and playing a content with a neighboring electronic device is executed as shown in FIG. 11, the processor 420 may display a content sharing icon 1101. The processor 420 may detect that the event for sharing the content with a neighboring electronic device occurs, by detecting a user input on the content sharing icon 1101. In still another example, while displaying items 1111 indicating neighboring electronic devices registered at the electronic device and a convergence item 1113 as shown in FIG. 11, the processor 420 may detect that the event for sharing the content with a neighboring electronic device occurs, by detecting a user input on the convergence item 1113. The items 1111 indicating the neighboring electronic devices registered at the electronic device, and the convergence item 1113 in FIG. 11 may be displayed in response to the user input on the content sharing icon 1101.

The electronic device may transmit content information to the server in operation 903. The processor 420 may control the communication interface 470 to transmit content information to the server in response to the content sharing event with the neighboring electronic device being detected. The content information may include at least one of, for example, a type of the content, metadata of the content, and a content attribute. According to an embodiment, when the event for sharing the content with a specific neighboring electronic device (for example, a TV) designated by the user is detected as shown in FIG. 10, the processor 420 may control the communication interface 470 to transmit information regarding the neighboring electronic device designated for content sharing, and the content information to the server. The information regarding the neighboring electronic device designated for content sharing may include at least one of an ID, a product name, and a device type.

In operation 905, the electronic device may detect whether recommendation convergence configuration information is received from the server. For example, the processor 420 may detect whether the recommendation convergence configuration information is received from the server within a threshold time from the time of transmitting the content information. When the recommendation convergence configuration information is not received from the server, the processor 420 may determine that there does not exist the recommendation convergence configuration information, and may finish the operation procedure according to an embodiment of the disclosure. According to an embodiment, the processor 420 may display a message or a graphic image (for example, an icon) informing that there does not exist the recommendation convergence configuration information.

When the recommendation convergence configuration information is received from the server, the electronic device may display the recommendation convergence configuration information in operation 907. According to an embodiment, the processor 420 may display the received recommendation convergence configuration information on the display 460 in response to the recommendation convergence configuration information being received. According to an embodiment, in response to the recommendation convergence configuration information being received, the processor 420 may display a message 1001 informing that there exists a recommendation convergence configuration on the screen showing that the content is being played as shown in the third screen configuration of FIG. 10. When a user input for displaying the convergence configuration is detected, the processor 420 may display the recommendation convergence configuration information on the screen. According to an embodiment, in response to a user input on the convergence item 1113 being detected as shown in the third screen configuration of FIG. 11, the processor 420 may display the recommendation convergence configuration information on the screen. The recommendation convergence configuration information may include at least one of information of a content output device and information of an environment creation device. According to an embodiment, when the information of the environment creation device is included in the recommendation convergence configuration information, the processor 420 may display, on the display 460, at least one of identification information of the environment creation device, an icon, a sign, a product name, a device type, a current operation mode, user information corresponding to the current operation mode, a network connection state, and a recommendation operation mode, based on the information of the environment creation device received. According to an embodiment, when the information of the content output device is included in the recommendation convergence configuration information, the processor 420 may display, on the display 406, at least one of identification information of the content output device, an icon, a sign, a product name, a device type, information on whether the content output device is used by another user, and a network connection state, based on the information of the content output device received. For example, as shown in FIG. 12A, the processor 420 may display, on the display 460, information indicating that the robot cleaner and the air purifier are recommended as the environment creation device, and a recommendation operation mode of the robot cleaner is “stop cleaning” and a recommendation operation mode of the air purifier is “Fan speed: Low”, based on the received recommendation convergence configuration information. In another example, as shown in FIG. 12B, the processor 420 may display information indicating that the first speaker, the second speaker, and the TV are recommended as the content output devices, and the robot cleaner and the air purifier are recommended as the environment creation devices, and the first speaker, the second speaker, and the TV are currently connected to a network, and the recommendation operation of the robot cleaner is “stop cleaning” and the recommendation operation mode of the air purifier is “Fan speed: Low”, based on the received recommendation convergence configuration information. According to an embodiment, the processor 420 may display the recommendation convergence configuration information on the display 460 based on whether the content output devices are used by other users. For example, as shown in FIG. 13A, the processor 420 may add graphic images 1301, 1303 indicating other users to items indicating information of the first speaker and the second speaker in order to indicate that the first speaker and the second speaker are being used by other users, and the TV is not being used by other users. In another example, as shown in FIG. 13B, the processor 420 may display setting items of the first speaker and the second speaker, which are being used by other users, in Off states 1311, 1313, and may set the setting item of the TV, which is not being used by other users, to an On state 1315. According to an embodiment, when at least one content output device is being used by another user, the processor 420 may display the recommendation convergence configuration information, based on at least one of a priority of another user and a priority of the user of the electronic device 401, and a priority of another electronic device of another user and a priority of the electronic device 401. For example, when a priority of a first user using the first speaker is higher than the priority of the user of the electronic device 401, and a priority of a second user using the second speaker is lower than the priority of the user of the electronic device 401, the processor 420 may display the setting item of the first speaker in the Off state 1321, and display the setting item of the second speaker in the On state 1323 as shown in FIG. 13C. The methods for displaying the recommendation convergence configuration information shown in FIGS. 12A, 12B, 13A, 13B, and 13C are merely examples, and the disclosure is not limited thereto. For example, the processor 420 may inactivate the setting item of the content output device, based on whether the content output device is used by another user, the priority of another user, and/or the priority of another electronic device related to another user, and may prevent the corresponding content output device from being selected by a user input. In another example, the processor 420 may omit displaying of the content output device included in the recommendation convergence configuration information, based on whether the content output device is used by another user, the priority of another user, and/or the priority of another electronic device related to another user. For example, when the priority of the first user using the first speaker is higher than the priority of the user of the electronic device 401, and the priority of the second user using the second speaker is lower than the priority of the user of the electronic device 401, the processor 420 may display the second speaker on the display 460 and may not display the first speaker on the display 460. In still another example, the processor 420 may display, on the display 460, priority information of another user using the content output device and/or priority information of another electronic device related to another user using the content output device. The priority information may be indicated by, for example, a color, a sign, an icon, a text, a font type, a font size, or a combination thereof. In yet another example, when a priority of the user corresponding to the current operation mode of the environment creation device is higher than the priority of the user of the electronic device 401, or a priority of an electronic device related to the user corresponding to the current operation mode is higher than the priority of the electronic device 401, the processor 420 may inactivate the setting item for setting the operation mode of the environment creation device, and may prevent the operation mode of the corresponding environment creation device from being changed by a user input. In further example, the processor 420 may activate the setting item for setting the operation mode of the corresponding environment creation device, without considering the priority of the user corresponding to the current operation mode of the environment creation device, and/or the priority of the electronic device related to the user corresponding to the current operation mode, and may control to determine the operation mode of the environment creation device based on a user input.

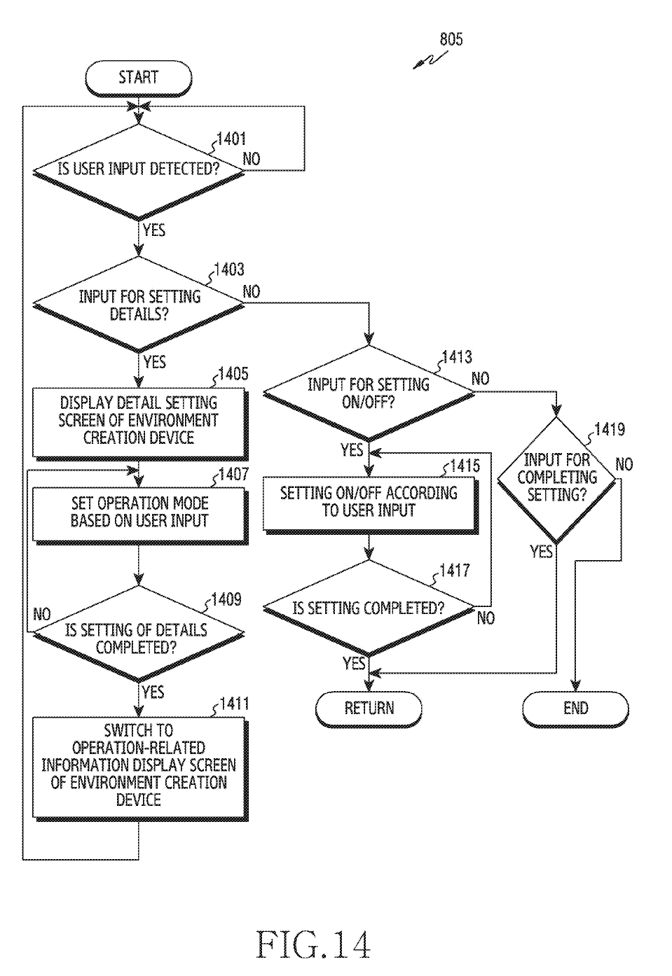

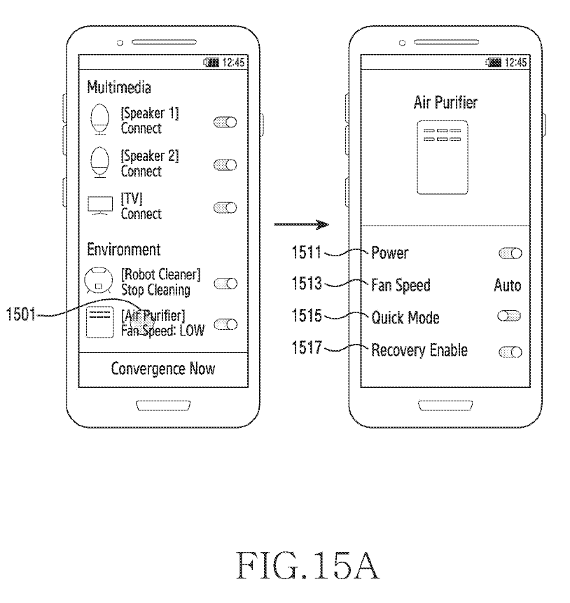

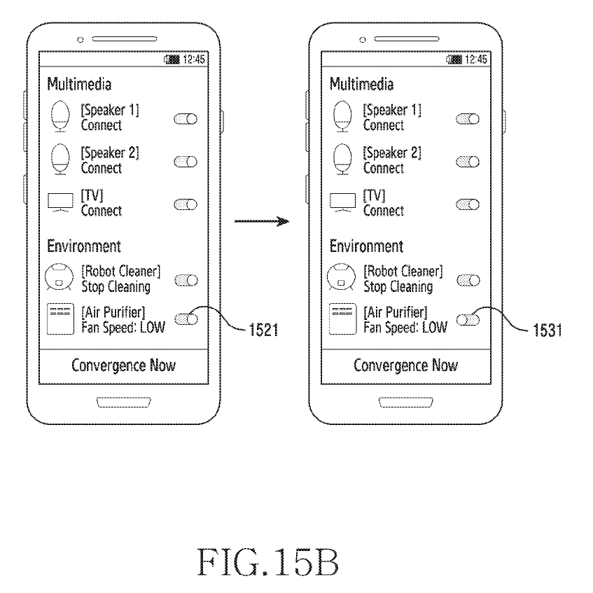

FIG. 14 is a view illustrating an operation procedure for setting an operation mode of a neighboring electronic device in an electronic device according to various embodiments of the disclosure. Hereinafter, operation 805 of FIG. 8 will be described in detail. In embodiments described below, operations may be performed in sequence, but may not necessarily be performed in sequence. For example, the order of operations may be changed and at least two operations may be performed in parallel. Herein, the electronic device may be the electronic device 100 of FIG. 1, the electronic device 200 of FIG. 2, or the electronic device 401 of FIG. 4. The operation procedure of FIG. 14 will be described with reference to FIGS. 15A and 15B. FIGS. 15A and 15B illustrate screen configurations for setting an operation mode of a neighboring electronic device in an electronic device according to various embodiments of the disclosure.

Referring to FIGS. 14, 15A, and 15B, the electronic device may determine whether a user input is detected in operation 1401. According to an embodiment, the processor 402 may determine whether a user input on the display 460 is detected while displaying information regarding an environment creation device on the screen.

When the user input is detected, the electronic device may determine whether the detected user input is an input for setting details of the environment creation device in operation 1403. According to an embodiment, when the user input is detected while information regarding the environment creation device is displayed on the screen, the processor 420 may determine whether the user input is an input for setting details regarding the operation of the environment creation device, based on a region where the user input is detected and a user input method (for example, a double touch, a long touch, etc.). For example, when a user input on the region where the information of the environment creation device is displayed is detected, or when a user input on the region where detail setting items on the environment creation device are displayed is detected, the processor 420 may determine that the input for setting details is detected. For example, as shown in FIG. 15A, when a user input 1501 on a region where the information of the air purifier, which is an environment creation device, is displayed is detected, the processor 420 may determine that the input for setting details is detected. In another example, when a double touch on the region where the information of the environment creation device is displayed is detected, the processor 420 may determine that the input for setting details on the environment creation device is detected.

When the detected user input is the input for setting details, the electronic device may display a detail setting screen of the environment creation device in operation 1405. According to an embodiment, the detail setting screen may include at least one of at least one detail item related to the operation of the environment creation device, a recommendation operation mode for the detail item, and setting-related information for the detail item. At least one of the at least one detail item, the recommendation operation mode for the detail item, and the setting-related information for the detail time, which are included in the detail setting screen, may be determined based on content information, a convergence configuration designated by the user, a using history, real-time states of neighboring electronic devices, a location of the electronic device, locations of the neighboring electronic devices, time, surrounding environment information, or a combination thereof. For example, the detail setting screen may include, as the detail item related to the operation of the environment creation device, at least one of an item for setting power on/off, an item for setting an operation mode in the power-on state, and an item for setting whether to restore to a current operation mode after playing of the content is ended. The power on/off setting item and the operation mode setting item included in the detail setting screen may be set and displayed to indicate a current operation mode, or may be set or displayed to indicate a recommendation operation mode, which is determined based on content information, a convergence configuration designated by the user, a using history, real-time states of neighboring electronic devices, a location of the electronic device, locations of the neighboring electronic devices, time, surrounding environment information, or a combination thereof, or a default operation mode. For example, as shown in FIG. 15A, the detail setting screen of the air purifier, which is an environment creation device, may include an item 1511 for setting power on/off, an item 1513 for setting a fan speed, an item 1515 for setting a quick mode, and an item 1517 for setting an operation mode recovery. The detail setting screen illustrated in FIG. 15A is an example and various embodiments of the disclosure are not limited thereto. For example, the detail setting screen may include other setting items related to the environment creation device. According to an embodiment, the processor 420 may inactivate and display some of the items included in the detail setting screen, based on the priority of the user instructing the current operation mode of the environment creation device, and the priority of the electronic device related to the user instructing the current operation mode of the environment creation device. For example, when the air purifier currently operates in a quick mode, and the priority of the first user instructing the quick mode is higher than the priority of the user of the electronic device 401, or the priority of the first electronic device related to the first user is higher than the priority of the electronic device 401, the processor 420 may inactivate and display the setting item on the quick mode on the detail setting screen, and may control to prevent setting on the quick mode from being changed by the electronic device 401. In another example, the processor 420 may inactivate and display some of the items included in the detail setting screen, regardless of the priority of the user instructing the current operation mode of the environment creation device, and the priority of the electronic device related to the user instructing the current operation mode of the environment creation device. For example, the processor 420 may inactivate and display the setting item on the power on/off on the detail setting screen, and may control to prevent setting on the power on/off from being changed by the electronic device 401.

The electronic device may set the operation mode based on a user input in operation 1407. For example, when a change of the fan speed from Auto to Low is detected based on a user input, while the detail setting screen on the air purifier is displayed as shown in FIG. 15A, the processor 420 may set the fan speed of the air purifier to a low speed. In another example, when it is detected that the item for setting the recovery changes from the Off state to the On state by a user input, while the detail setting screen on the air purifier is being displayed as shown in FIG. 15A, the processor 420 may set the recovery mode of the air purifier to be activated.

The electronic device may determine whether setting of the details is completed in operation 1409. For example, when a detail setting completion item is selected or a user input for returning to a previous screen is detected (for example, a cancel item is selected), the processor 420 may determine that setting of the details is completed.

When setting of the details is completed, the electronic device may switch to an operation-related information display screen of the environment creation device in operation 1411. For example, when setting of the details is completed while the detail setting screen of the environment creation device is being displayed on the display 460, the processor 420 may display the operation-related information of the environment creation device that has been displayed on the display 460 before the detail setting screen of the environment creation device is displayed. For example, the processor 420 may control the display 460 to switch from the detail setting screen of the air purifier shown on the right view of FIG. 15A to the screen shown on the left view of FIG. 15B.

When the detected user input is not the input for setting details, as a result of performing operation 1403, the electronic device may determine whether the user input is an input for setting On/Off in operation 1413. According to an embodiment, when the user input is detected while information on the environment creation device is being displayed on the screen, the processor 420 may determine whether the user input is an input for determining whether to set the environment creation device in a recommendation operation mode, based on at least one of the region where the user input is detected, and a user input method. For example, when a user input 1521 on the region where the setting item on the recommendation operation mode (fan speed: low) of the air purifier, which is an environment creation device, is displayed is detected as shown in FIG. 15B, the processor 420 may determine that the input for setting On/Off is detected.

The electronic device may set On/Off based on a user input in operation 1415. According to an embodiment, the processor 420 may set the recommendation operation mode on the environment creation device to On or Off based on a user input. For example, the processor 420 may set the fan speed of the air purifier to a low speed while playing the content of the electronic device, by setting the setting item on the recommendation operation mode (fan speed: low) of the air purifier to the On state 1521 based on a user input as shown in FIG. 15B. In another example, the processor 420 may set not to control the operation mode of the air purifier while playing the content of the electronic device, by changing the setting on the recommendation operation mode of the air purifier to the Off state 1531 based on a user input as shown in FIG. 15B.

The electronic device may determine whether setting on the environment creation device is completed in operation 1417. For example, when the setting completion item on the environment creation device is selected, the processor 420 may determine that setting on the environment creation device is completed. For example, when the item “Convergence now” on the left view of FIG. 15A or on the screens illustrated in FIG. 15B is selected, it may be determined that the setting on the environment creation device is completed.

When the detected user input is not the input for setting On/Off as a result of performing operation 1413, the electronic device may determine whether the detected user input is an input for completing setting on the environment creation device in operation 1419. According to an embodiment, when the user input is detected while the information on the environment creation device is being displayed, the processor 420 may determine whether the user input is an input for completing setting on the environment creation device based on at least one of the region where the user input is detected, and a user input method. For example, when the user input on a region where a setting completion item on the environment creation device is displayed is detected, the processor 420 may determine that the user input is the input for completing setting on the environment creation device.

When the detected user input is not the input for completing setting on the environment creation device as a result of performing operation 1417, the electronic device may perform a function corresponding to the user input, and may finish the operation procedure according to an embodiment of the disclosure. For example, when a user input for returning to a previous screen is detected (for example, a cancel item is selected) while the information on the environment creation device is displayed, the electronic device may finish the operation procedure according to an embodiment of the disclosure.

In FIG. 14, the environment creation device has been described by way of an example. However, FIG. 14 can be equally applied to the content output device. For example, the electronic device may display a detail setting screen for the content output device on the display 460 based on a user input. In another example, the electronic device may set a setting item indicating whether the content output device is used to the On or Off state, based on a user input. According to an embodiment, when a setting item on a first content output device is set to the On state based on a user input, while information on the plurality of content output devices is displayed, the electronic device may automatically set a setting item of at least one other content output device, except for the first content output device, to the Off state in response to this. For example, when it is detected that a setting item of a first audio device is set to the On state based on a user input, while information on the first audio device (for example, the first speaker) and a second audio device (for example, the second speaker) is displayed, the electronic device may set a setting item of the second audio device to the Off state in response to this. This is merely an example, and the disclosure is not limited thereto. For example, even when it is detected that a setting item on a first content output device is set to the On state based on a user input, while information on a plurality of content devices is displayed, the electronic device may not change the On/Off state of the setting item of at least one other content output device.

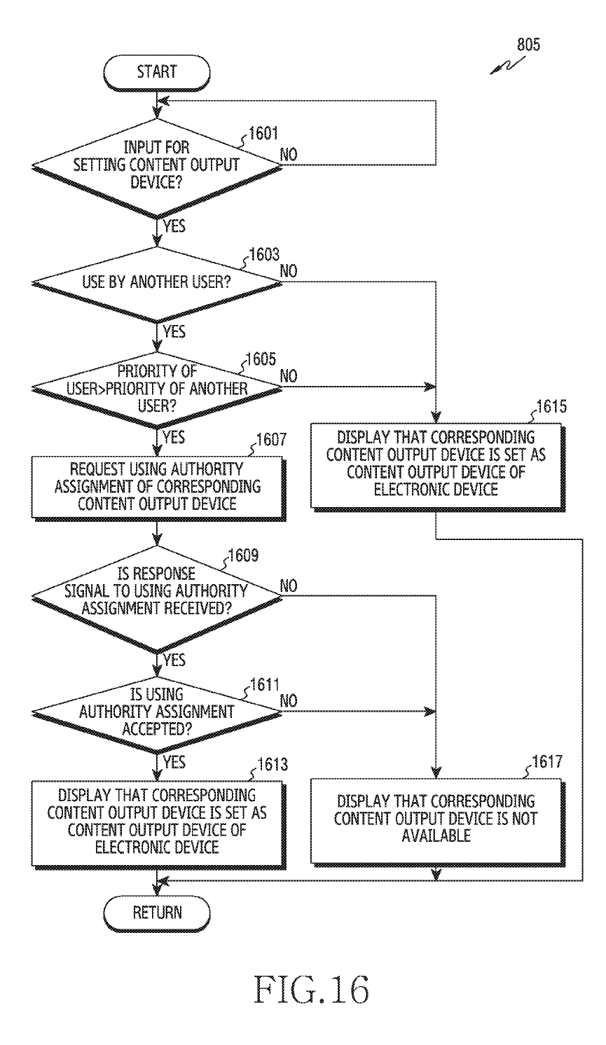

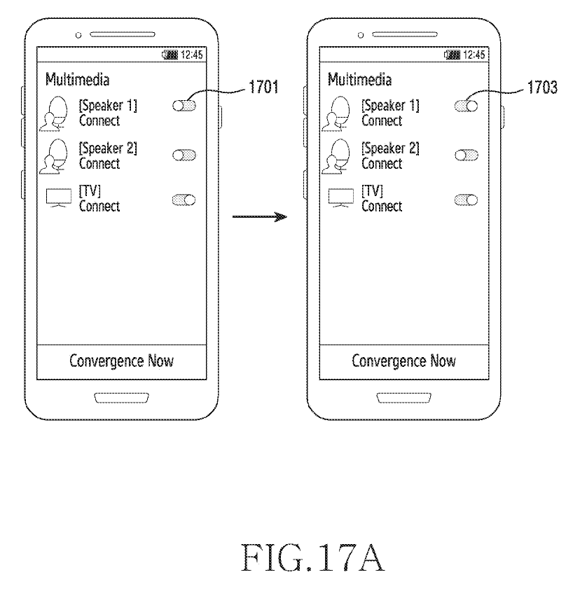

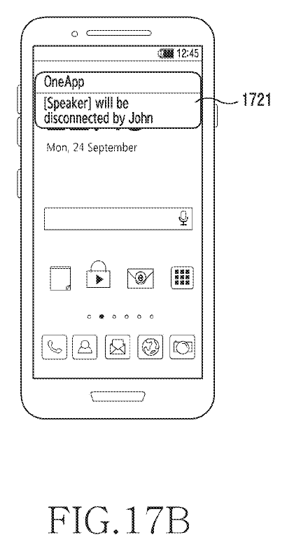

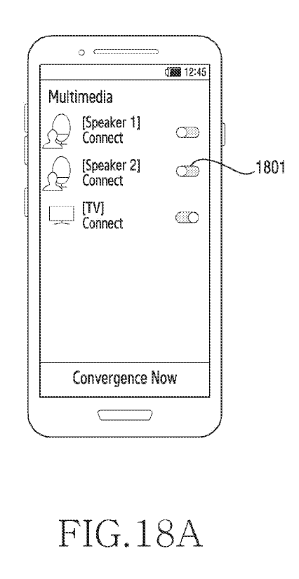

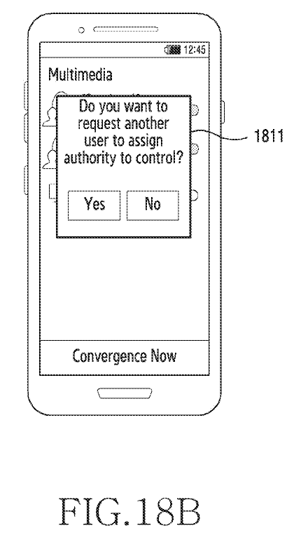

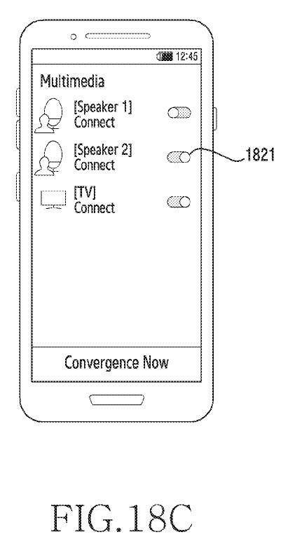

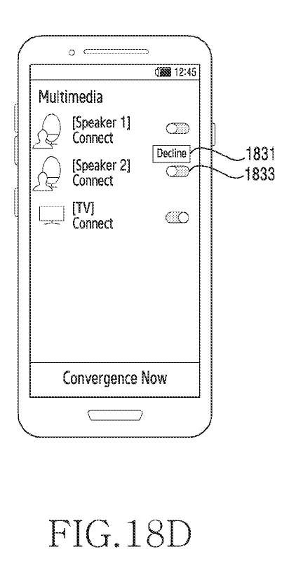

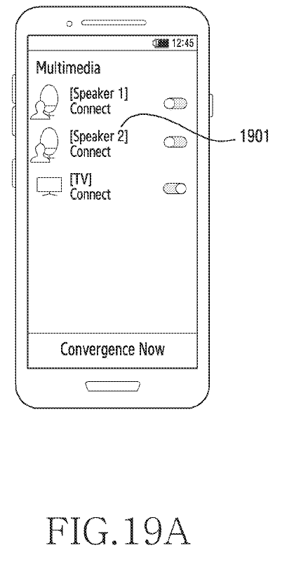

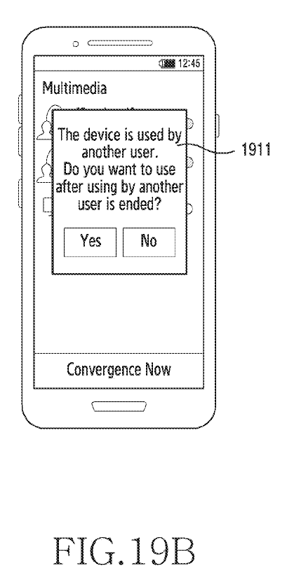

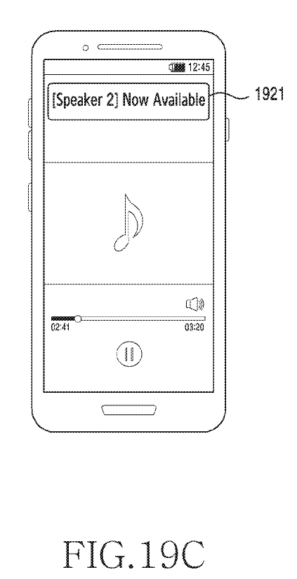

FIG. 16 is a view illustrating an operation procedure for setting a neighboring electronic device to output a content in an electronic device according to various embodiments of the disclosure. Hereinafter, operation 805 of FIG. 8 will be described in detail. In embodiments described below, operations may be performed in sequence, but may not necessarily be performed in sequence. For example, the order of operations may be changed and at least two operations may be performed in parallel. Herein, the electronic device may be the electronic device 100 of FIG. 1, the electronic device 200 of FIG. 2, or the electronic device 401 of FIG. 4. In the following description, the operation procedure of FIG. 16 will be described with reference to FIGS. 17A, 17B, 18A, 18B, 18C, 18D, 19A, 19B, and 19C. FIG. 17A illustrates a screen configuration for setting a neighboring electronic device to output a content in an electronic device according to various embodiments of the disclosure. FIG. 17B illustrates a screen configuration indicating that authority to use a neighboring electronic device is lost in another electronic device according to various embodiments of the disclosure. FIGS. 18A, 18B, 18C, and 18D are views illustrating a screen configuration for taking over authority to use a neighboring electronic device based on a priority in an electronic device according to various embodiments of the disclosure. FIGS. 19A, 19B, and 19C are views illustrating a screen configuration for using a neighboring electronic device based on a priority in an electronic device according to various embodiments of the disclosure.

Referring to FIG. 16, the electronic device may determine whether a user input for setting a content output device to a content output device of the electronic device is detected in operation 1601. For example, the electronic device may determine whether a user input on a region where a content output device is displayed is detected, while displaying information on at least one content output device on the screen. For example, as shown in FIG. 17A, the electronic device may determine whether a user input for changing a setting item the On state to set any one of the first speaker, the second speaker, and the TV to the content output device of the electronic device is detected, while displaying the information on the first speaker, the second speaker, and the TV.

When the user input for setting the content output device as the content output device of the electronic device is detected, the electronic device may identify whether the content output device corresponding to the user input is used by another user in operation 1603. According to an embodiment, the processor 420 may determine whether the content output device is used by another user, based on recommendation convergence configuration information.

When it is identified that the content output device corresponding to the user input is not used by another user, the electronic device may display that the content output device corresponding to the user input is set as the content output device of the electronic device in operation 1615. For example, the processor 420 may control the display 460 to show the On state of the setting item of the content output device corresponding to the user input.

When it is identified that the content output device corresponding to the user input is used by another user, the electronic device may compare the priority of the user of the electronic device and the priority of another user using the corresponding content output device in operation 1605. According to an embodiment, the processor 420 may obtain information regarding the priority of the user of the electronic device and the priority of another user from the recommendation convergence configuration information. According to an embodiment, the processor 420 may pre-obtain the information regarding the priority of the user of the electronic device and the priority of at least one other user from the server, and may store the information.

When the priority of the user of the electronic device is higher than the priority of another user, the electronic device may display that the content output device corresponding to the user input is set as the content output device of the electronic device in operation 1615. The electronic device may control the display 460 to show the On state of the setting item of the content output device corresponding to the user input. For example, when the user input for setting the first speaker as the content output device of the electronic device is detected, and the priority of the user of the electronic device is higher than the priority of the first user using the first speaker as shown in FIG. 17A, the processor 420 may change the setting item of the first speaker from the Off state 1701 to the On state 1703, and display that the first speaker is set as the content output device of the electronic device. According to an embodiment, the electronic device may transmit a disconnection notification signal to the electronic device of another user corresponding to the content output device, while changing the setting item of the content output device from the Off state to the On state, and displaying. According to an embodiment, the electronic device of another user may receive the disconnection notification signal, and, in response to this, may display a message 1721 informing that the first speaker will be disconnected by the user of the electronic device on the screen as shown in FIG. 17B. The disconnection notification signal may include at least one of information indicating that the electronic device of another user and the corresponding content output device are disconnected from each other, and information indicating that the electronic device will use the corresponding content output device. The disconnection notification signal may be transmitted from the electronic device to another electronic device via the server, or may be directly transmitted from the electronic device to another electronic device.

When the priority of the user of the electronic device is lower than the priority of another user, the electronic device may transmit a using authority assignment request signal regarding the corresponding content output device in operation 1607. The using authority assignment request signal may be transmitted from the electronic device to another electronic device via the server, or may be directly transmitted from the electronic device to another electronic device. For example, when a user input to a setting item 1801 for setting the second speaker as the content output device of the electronic device is detected as shown in FIG. 18A, and the priority of the user of the electronic device is lower than the priority of the second user using the second speaker, the processor 420 may transmit, to the electronic device of the second user, a signal requesting the electronic device of the second user to assign the authority to use the second speaker. According to an embodiment, in response to the user input for setting the second speaker as the content output device of the electronic device being detected, the processor 420 may display a message asking if the user wishes to transmit a message 1811 asking another user to assign the using authority as shown in FIG. 18B. When it is identified that the transmission of the using authority assignment message is accepted, the processor 420 may transmit a signal requesting the electronic device of the second user to assign the authority to use the second speaker to the electronic device of the second user.

The electronic device may determine whether a response signal to the using authority assignment is received in operation 1609. According to an embodiment, the processor 420 may wait for the response signal within a threshold time from the time of transmitting the message requesting the using authority assignment.

When the response signal to the using authority assignment is not received, the electronic device may display that the corresponding content output device cannot be used in operation 1617. For example, the processor 420 may display, on the display 460, a message or a graphic image indicating that the corresponding content output device cannot be used. In another example, the processor 420 may display the setting item on the corresponding output device in the Off state. In still another example, the processor 420 may display that the corresponding content output device cannot be used by inactivating the setting item of the corresponding content output device, and may control to prevent the setting item of the corresponding content output device from being changed to the On state by a user input.

When the response signal to the using authority assignment is received, the electronic device may determine that the response signal is a signal accepting the using authority assignment in operation 1611. The response signal to the using authority assignment may be any one of a signal accepting the using authority assignment or a signal decline the using authority assignment.

When the response signal is the signal accepting the using authority assignment, the electronic device may display that the corresponding content output device is set as the content output device thereof in operation 1613. For example, the processor 420 may change the setting item of the second speaker to the On state 1821 as shown in FIG. 18C, and display that the second speaker is set as the content output device of the electronic device.

When the response signal is the signal declining the using authority assignment, the electronic device may display that the corresponding content output device cannot be used in operation 1617. For example, the processor 420 may change the setting item of the second speaker to the Off state 1833 as shown in FIG. 18D, and display that the second speaker cannot be set as the content output device of the electronic device. The processor 420 may display a message or graphic image 1831 indicating that the using authority assignment of the second speaker is declined by the user of the second speaker. In another example, the processor 420 may display that the second speaker cannot be used as the content output device by inactivating the setting item of the second speaker, and may control to prevent the setting item of the second speaker from being changed to the On state by a user input.

Although not shown in FIG. 16 described above, according to various embodiments, when the content output device is used by another user electronic device, the electronic device may set the corresponding content output device to be used after using by another user electronic device is ended. For example, when a user input 1901 on the second speaker which is being used by the second user is detected as shown in FIG. 19A, the electronic device may display a message 1911 asking if the user of the electronic device wishes to use after using by another user is ended as shown in FIG. 19B. When a user input for using the second speaker after the end of using by another user is detected, and the use of the speaker by the second user is ended, the electronic device may transmit a signal for requesting to notify of the end of use. The signal for requesting to notify of the end of use may be transmitted from the electronic device to the electronic device of the second user via the server, or may be directly transmitted from the electronic device to the second user. When a notification signal indicating the end of use of the second speaker is received from the electronic device of the second user and/or the server, while the content is being played, the electronic device may display a message 1921 indicating that the second speaker is available as shown in FIG. 19C. According to various embodiments, when the using authority assignment declining signal regarding the content output device is received from the electronic device of another user, or when the response signal to the using authority assignment is not received, the electronic device may display the message asking if the user wishes to use after the end of use by another user as shown in FIG. 19B, thereby guiding the user to select whether to wait for use of the content output device.

In FIG. 16 described above, the electronic device operates based on the priority of the user of the electronic device and the priority of another user using the content output device. However, according to various embodiments, the electronic device may perform the operations as shown in FIG. 16, based on the priority of the electronic device and the priority of another electronic device related to another user using the content output device.

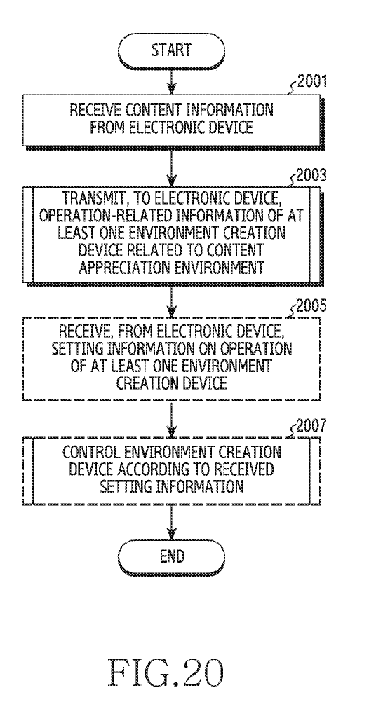

FIG. 20 is a view illustrating an operation procedure for controlling a neighboring electronic device to play a content of an electronic device in a server device according to various embodiments of the disclosure. In embodiments described below, operations may be performed in sequence, but may not necessarily be performed in sequence. For example, the order of operations may be changed and at least two operations may be performed in parallel. The operations illustrated in dashed lines in FIG. 20 may be omitted according to an embodiment. Herein, the server device may be the server 120 of FIG. 1, the server 220 of FIG. 2, or the server 701 of FIG. 7.

Referring to FIG. 20, the server device may receive content information from an electronic device in operation 2001. The content information may include at least one of, for example, a content type, metadata of a content, or attribute information of the content.

In operation 2003, the server device may transmit, to the electronic device, operation-related information of at least one environment creation device related to a content appreciation environment, based on the content information. According to an embodiment, the processor 720 may select at least one environment creation device that is predicted as influencing the content appreciation environment, based on the content information. For example, the processor 720 may identify neighboring electronic devices related to the electronic device based on user account information of the electronic device pre-registered at the server, and may select at least one environment creation device from among the identified neighboring electronic devices based on the content information. In another example, the processor 720 may select at least one environment creation device based on a convergence configuration designated by the user, a using history of the neighboring electronic devices of the electronic device, real-time states of the neighboring electronic devices, locations of the electronic device and the neighboring electronic devices, time, or a combination thereof. The operation-related information of the environment creation device may include at least one of, for example, identification information of the environment creation device, a current operation mode, and a recommendation operation mode. According to various embodiments, the processor 720 may select at least one content output device based on the content information, the convergence configuration designated by the user, the using history of the neighboring electronic devices of the electronic device, the real-time states of the neighboring electronic devices, the locations of the electronic device and the neighboring electronic devices, time, or a combination thereof, and may transmit information regarding the content output device to the electronic device along with the operation-related information of the environment creation device.

In operation 2005, the server device may receive setting information regarding the operation of the at least one environment creation device from the electronic device. According to an embodiment, the processor 720 may receive a signal including the identification information of the at least one environment creation device and information regarding a set operation mode from the electronic device. According to an embodiment, the signal received from the electronic device may further include identification information of the at least one content output device.

In operation 2007, the server device may control the environment creation device based on the received setting information. For example, the processor 720 may identify an operation mode set for the environment creation device based on the received setting information, and may transmit a control signal instructing the environment creation device to operate in the identified operation mode. For example, when a signal indicating “Robot cleaner: temporarily stop cleaning,” “Air purifier-fan speed: low” is received from the electronic device, the processor 720 may transmit a control signal instructing the robot cleaner to temporarily stop cleaning, and may transmit a control signal instructing the air purifier to operate at a low fan speed. According to an embodiment, when the signal received from the electronic device includes the identification information of the at least one content output device, the processor 720 may transmit a control signal instructing the corresponding content output device to connect to the electronic device. The control signal instructing to connect to the electronic device may include information necessary for connecting to the electronic device.

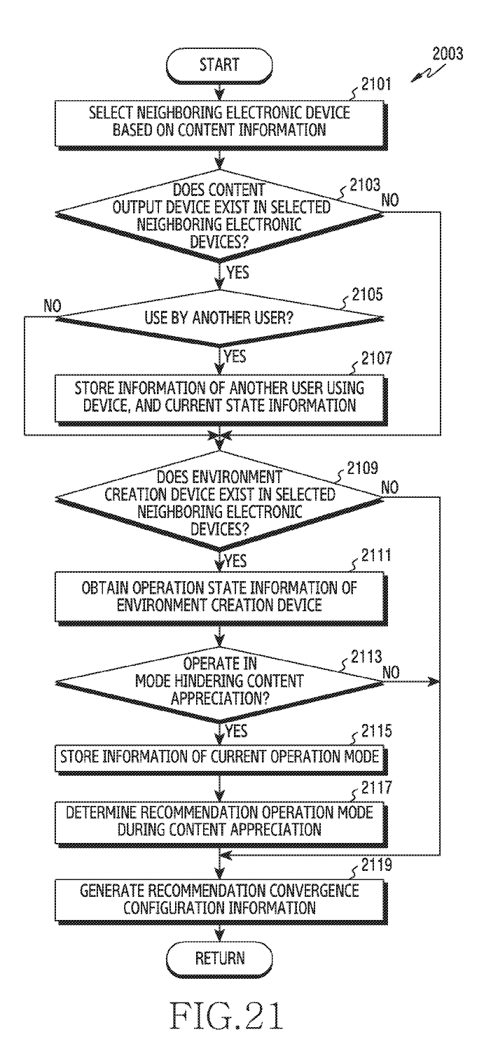

FIG. 21 is a view illustrating an operation procedure for transmitting information regarding a recommendation neighboring electronic device in a server device according to various embodiments of the disclosure. Hereinafter, operation 2003 of FIG. 20 will be described in detail. In embodiments described below, operations may be performed in sequence, but may not necessarily be performed in sequence. For example, the order of operations may be changed and at least two operations may be performed in parallel. Herein, the server device may be the server 120 of FIG. 1, the server 220 of FIG. 2, or the server 701 of FIG. 7.

Referring to FIG. 21, the server device may select a neighboring electronic device based on the content information in operation 2101. For example, the server device may select at least one neighboring electronic device corresponding to the content information from among neighboring electronic devices of the electronic device. The service device may identify the neighboring electronic devices of the electronic device based on user account information of the electronic device and/or location information of the electronic device. According to an embodiment, the server device may select at least one content output device and/or at least one environment creation device corresponding to a content type, based on a recommendation convergence configuration table as shown in table 2. According to an embodiment, the server device may select at least one content output device and/or at least one environment creation device corresponding to the content type, based on a convergence configuration designated by the user, a using history of the neighboring electronic devices of the electronic device, real-time states of the neighboring electronic devices, locations of the electronic device and the neighboring electronic devices, time, or a combination thereof.

In operation 2103, the server device may determine whether a content output device is included in the selected neighboring electronic devices. When a content output device is included, the server device may determine whether the corresponding content output device is being used by an electronic device of another user in operation 2105. For example, the server device may determine whether the corresponding content output device shares a content with the electronic device of another user and is outputting the shared content, based on history information of the corresponding content output device. Alternatively, the server device may determine whether the corresponding content output device is being used by the electronic device of another user, based on history information of an account of another user registered at the server.

When the corresponding content output device is being used by the electronic device of another user, the server device may store information of another user who is using the corresponding content output device, and current state information. The current state information may include information related to a task which is being performed, log information of an application which is being executed, communication connection information, a task performing situation, information on an error and a breakdown, an operation mode and a detail setting mode, an on/off state, etc. According to an embodiment, when the corresponding content output device is being used by the electronic device of another user, the server device may notify the electronic device of another user that the corresponding content output device may be disconnected. For example, the server device may notify the electronic device of another user, in advance, that the electronic device may use the corresponding content output device to share a content. When the corresponding content output device is not being used by the electronic device of another user, the server device may proceed to operation 2109. According to an embodiment, when the corresponding content output device is being used by the electronic device of another user, the server device may store the current state information of the corresponding content output device in operation 2107, and may proceed to operation 2109. According to an embodiment, when the corresponding content output device is not being used by the electronic device of another user, the processor 720 may store the current state information of the corresponding content output device.

In operation 2109, the server device may determine whether an environment creation device is included in the selected neighboring electronic devices. When an environment creation device is included, the server device may obtain operation state information of the corresponding environment creation device in operation 2111. The processor 720 may obtain the operation state information of the environment creation device based on a state message periodically received. The processor 720 may request the environment creation device to transmit the state information, and may obtain the state information in response to this request.

In operation 2113, the server device may determine whether the environment creation device operates in a mode that hinders appreciation of the content. For example, the processor 720 may determine whether the environment creation device operates in the mode that hinders the appreciation of the content, based on the operation state information of the environment creation device and the content type. According to an embodiment, the processor 720 may store and manage information regarding a hindering operation mode of the environment creation device according to a content type. For example, the server device may store information indicating that modes such as a cleaning mode of a robot cleaner, a high fan speed mode of an air purifier, or a spin-dry mode of a washing machine are hindering modes against music contents.

When it is determined that the environment creation device operates in the mode that hinders the appreciation of the content, the server device may store information on the current operation mode in operation 2115. For example, the processor 720 may store the information on the current operation mode to restore the environment creation device to the original mode when the appreciation of the content of the electronic device is ended.

In operation 2117, the server device may determine a recommendation operation mode during the appreciation of the content. For example, the processor 720 may determine a mode that does not hinder appreciation experience of the content of the electronic device, or a mode that augments the content appreciation experience as the recommendation operation mode. According to an embodiment, the processor 720 may store and manage information regarding a recommendation operation mode of the environment creation device according to a content type. For example, the processor 720 may store information indicating that modes such as a temporary cleaning stopping mode of the robot cleaner, a low fan speed mode of the air purifier, or a temporary washing stopping mode of the washing machine are recommendation operation modes for music contents.

In operation 2119, the server device may generate recommendation convergence configuration information. For example, the server device may generate recommendation convergence configuration information including information regarding at least one content output device and/or at least one environment creation device. The recommendation convergence configuration information may include at least one of identification information of the content output device, information whether the content output device is used by another user, information on the user who is using the content output device, current state information on the content output device, identification information of the environment creation device, current operation mode information of the environment creation device, recommendation operation mode of the environment creation device, and user information corresponding to the current operation mode of the environment creation device.

In FIG. 21 described above, the server device receives the content information from the electronic device, and selects the neighboring electronic devices based on the content information. However, according to an embodiment, the server device may receive, from the electronic device, information on the content output device along with the content information. For example, as shown in FIG. 10, when an event for sharing and playing a content through the TV is detected based on a user input on the electronic device, the electronic device may transmit TV information to the server device along with the content information. When the information on the content output device is received along with the content information, the server device may select neighboring electronic devices by considering the content information and the content output device. For example, since the electronic device already shares the content with the TV, the server device may select devices that are recommended as being used with the TV from among the neighboring electronic devices.

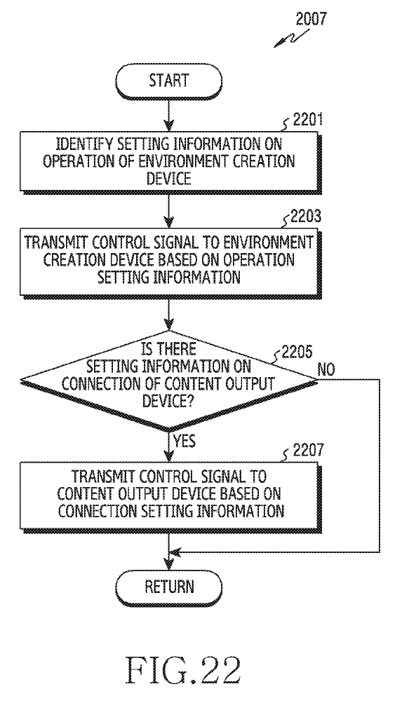

FIG. 22 is a view illustrating an operation procedure for controlling a neighboring electronic device based on determination of an electronic device in a server device according to various embodiments of the disclosure. Hereinafter, operation 2007 of FIG. 20 will be described in detail. In embodiments described below, operations may be performed in sequence, but may not necessarily be performed in sequence. For example, the order of operations may be changed and at least two operations may be performed in parallel. Herein, the server device may be the server 120 of FIG. 1, the server 220 of FIG. 2, or the server 701 of FIG. 7.

Referring to FIG. 22, the server device may identify setting information regarding an operation of an environment creation device in operation 2201. For example, the processor 720 may identify identification information of the environment creation device and information on an operation mode of the environment creation device, based on a signal received from the electronic device.

In operation 2203, the server device may transmit a control signal to the environment creation device based on the operation setting information. For example, the processor 720 may transmit a control signal instructing the environment creation device to operate in an identified operation mode. For example, when a signal indicating “Robot cleaner-temporary cleaning stop” and “Air purifier-fan speed: low” is received from the electronic device, the processor 720 may transmit a control signal instructing the robot cleaner to temporarily stop cleaning, and may transmit a control signal instructing the air purifier to operate at a low fan speed. According to an embodiment, the processor 720 may receive, from the environment creation device, a response signal indicating that the switch to the corresponding operation mode is made. According to an embodiment, the processor 720 may store information indicating that the environment creation device is switched to the corresponding operation mode by the electronic device.

In operation 2205, the server device may determine whether there exists setting information regarding a connection of a content output device. For example, the processor 720 may determine whether there exit identification information of the content output device and connection setting information of the content output device in the signal received from the electronic device.

When there exists the setting information regarding the connection of the content output device, the server device may transmit a control signal to the content output device based on the connection setting information in operation 2207. For example, the processor 720 may transmit a control signal instructing the content output device to connect to the electronic device. According to an embodiment, the control signal instructing to connect to the electronic device may include information necessary for connecting to the electronic device. According to an embodiment, the processor 720 may receive a response signal indicating that the connection is completed from the content output device and/or the electronic device. According to an embodiment, the processor 720 may store information indicating that the content output device is connecting to the electronic device. According to an embodiment, when the corresponding content output device is being used by the electronic device of another user, the server device may notify the electronic device of another user that the corresponding content output device will be disconnected.

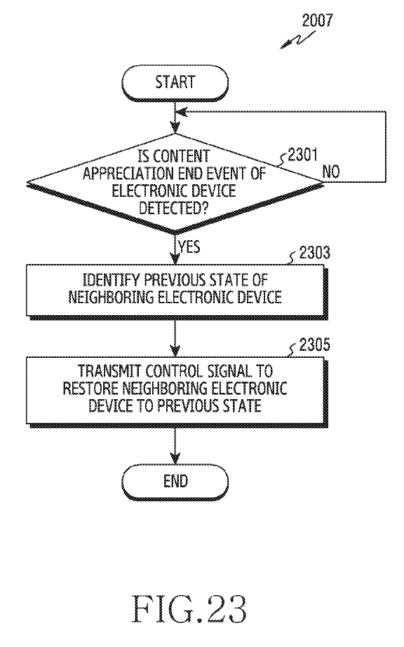

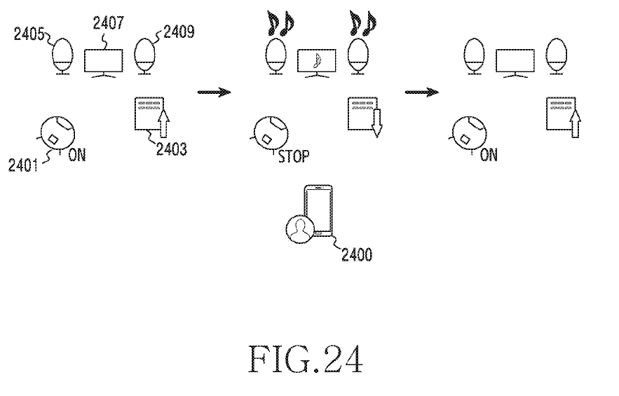

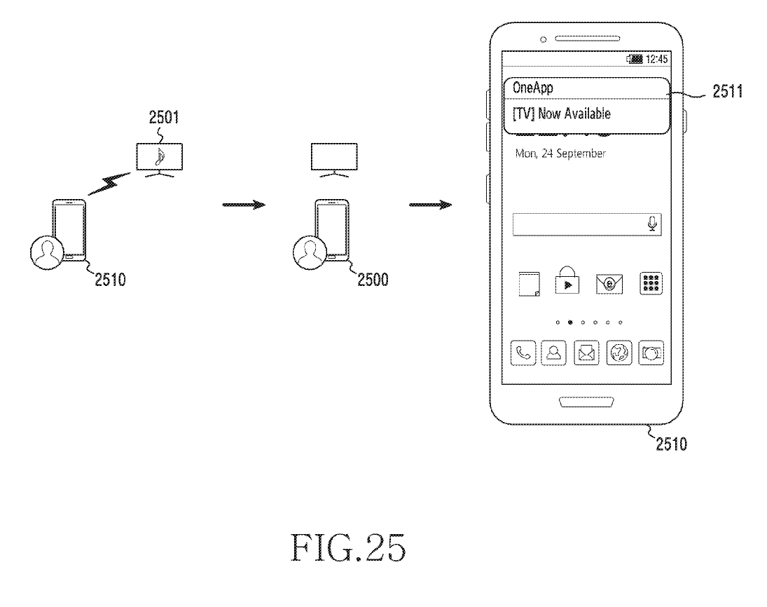

FIG. 23 is a view illustrating an operation procedure for restoring a state of a neighboring electronic device in a server device according to various embodiments of the disclosure. Hereinafter, operation 2007 of FIG. 20 will be described in detail. In embodiments described below, operations may be performed in sequence, but may not necessarily be performed in sequence. For example, the order of operations may be changed and at least two operations may be performed in parallel. Herein, the server device may be the server 120 of FIG. 1, the server 220 of FIG. 2, or the server 701 of FIG. 7. Hereinafter, FIG. 23 will be described with reference to FIGS. 24 and 25. FIGS. 24 and 25 are views illustrating an example in which a state of a neighboring electronic device is restored in a server device at a time when playing of a content of an electronic device is ended according to various embodiments of the disclosure.

Referring to FIG. 23, the server device may determine whether a content appreciation end event of the electronic device is detected in operation 2301. For example, the processor 720 may detect the content appreciation end event by receiving a signal indicating that the content appreciation is ended from the electronic device. In another example, the processor 720 may detect the content appreciation end event by receiving a state message from the content output device connected with the electronic device. In still another example, the processor 720 may detect the content appreciation end event by receiving a state message from an environment creation device the operation mode of which is controlled by the electronic device.

In operation 2303, the server device may identify a previous state of the neighboring electronic device. According to an embodiment, the processor 720 may obtain, from the memory 730, information regarding previous states of the content output device connected with the electronic device and/or the environment creation device the operation mode of which is changed by the electronic device. For example, the processor 720 may identify the state information of the content output device and the state information of the environment creation device which are stored during the operation of FIG. 21. In operation 2305, the server device may transmit a control signal for restoring the neighboring electronic device to the previous state. For example, the processor 720 may transmit a control signal including the previous state information to the content output device connected with the electronic device, and/or the environment creation device the operation mode of which is changed by the electronic device from among the neighboring electronic devices related to the electronic device. For example, as shown in FIG. 24, the processor 720 may identify that a first speaker 2405, a TV 2407, and a second speaker 2409, which are content output devices of an electronic device 2400, were operating in a “standby mode” before they are connected with the electronic device 2400, and may identify that a robot cleaner 2401 and an air purifier 2403, which are environment creation devices of the electronic device 2400, were operating in a “cleaning mode” and a mode of “Fan speed: high,” respectively, before their operation modes are controlled by the electronic device 2400. When a content appreciation end event of the electronic device 2400 is detected, the processor 720 may transmit a control signal instructing to operate in the “standby mode” to the first speaker 2405, the TV 2407, and the second speaker 2409, and may transmit a control signal instructing to operate in the “cleaning mode” to the robot cleaner 2401, and may transmit a control signal instructing to operate in the mode of “Fan speed: high” to the air purifier 2403. In another example, as shown in FIG. 25, the processor 720 may identify that a TV 2501 which is a content output device of an electronic device 2500 was being used by an electronic device 2510 of another user before the TV 2501 is connected with the electronic device 2500. When a content appreciation end event of the electronic device 2500 is detected, the processor 720 may transmit a control signal instructing to connect to the electronic device 2510 of another user to the TV 2501, and may transmit a signal indicating that use of the TV 2501 by the electronic device 2500 is ended to the electronic device 2510 of another user. According to an embodiment, the electronic device 2510 of another user may display a message 2511 indicating that the TV 2501 is available on the screen, in response to the signal of the end of the use of the TV 2501 by the electronic device 2500.

In the above-described explanation, the electronic device receives the recommendation convergence configuration information through the server. However, the electronic device may generate recommendation convergence configuration information by directly transmitting and receiving signals to and from the neighboring electronic devices. For example, the electronic device may receive a state message from the neighboring electronic device, and may store and manage the state information of the neighboring electronic device. The electronic device may directly generate the recommendation convergence configuration information based on a content type, a convergence configuration designated by the user, a using history, real-time states of the neighboring electronic devices, location of the electronic device, locations of the neighboring electronic devices, surrounding environment information, time, or a combination thereof.

According to the electronic device and the operating method thereof according to various embodiments, the electronic device can optimize a user's content appreciation environment by controlling operations of a neighboring electronic device that hinders the content appreciation experience, and a neighboring electronic device that augments the content appreciation experience.

According to the electronic device and the operating method thereof according to various embodiments, the electronic device may share a content with a neighboring electronic device and play the content, based on whether other neighboring electronic devices are used by other users, such that a collision with other user electronic devices can be prevented when there are a plurality of user electronic devices like a home environment.

According to the electronic device and the operating method thereof according to various embodiments, the electronic device may receive, from the server, information regarding a neighboring electronic device that hinders the content appreciation experience, and a neighboring electronic device that augments the content appreciation experience, and display the information, such that user's understanding and utilization to share and play a content can be enhanced.

The term “module” used herein may refer to a unit including one of hardware, software, or firmware, or a combination of two or more of them. The “module” may be interchangeably used with the terms “unit,” “logic,” “logical block,” “component” or “circuit”. The “module” may be a minimum unit of an integrally configured component or a part thereof. The “module” may be a minimum unit for performing one or more functions or a part thereof. The “module” may be implemented mechanically or electronically. For example, the “module” may include an application-specific IC (ASIC) chip, a field-programmable gate array (FPGA), and a programmable-logic device for performing some operations, which are known or will be developed.

At least part of a device (for example, modules or functions thereof) or a method (for example, operations) according to various embodiments, for example, may be implemented by instructions stored in a non-transitory computer-readable storage medium in the form of a program module. When the instruction is executed by a processor (for example, the processor), one or more processors may perform a function corresponding to the instruction. The non-transitory computer-readable storage medium may be, for example, a memory.

Non-transitory computer-readable recording media may include a hard disk, a floppy disk, magnetic media (for example, a magnetic tape), optical media (for example, compact disc ROM (CD-ROM) and a digital versatile disc (DVD), magneto-optical media (for example, a floptical disk)), or a hardware device (for example, a ROM, a RAM, or a flash memory). Also, a program command may include not only a mechanical code such as things generated by a compiler but also a high-level language code executable on a computer using an interpreter. The above hardware device may be configured to operate via one or more software modules for performing an operation of various embodiments, and vice versa.

A module or a program module according to various embodiments may include at least one of the above elements, or a portion of the above elements may be omitted, or additional other elements may be further included. Operations performed by a module, a program module, or other elements according to various embodiments may be executed sequentially, in parallel, repeatedly, or in a heuristic method. Also, a portion of operations may be executed in different sequences, omitted, or other operations may be added.

The disclosure has been described with reference to various example embodiments thereof. It will be understood by a person skilled in the art that the disclosure can be implemented in modified forms without departing from the essential characteristics of the disclosure. Therefore, disclosed embodiments should be considered from a descriptive perspective, not from a limited perspective. The scope of the disclosure is defined not by the detailed description but by the appended claims, and all differences within the scope should be understood as being included in the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
a communication interface;
a memory; and
at least one processor operatively connected with the display, the communication interface, and the memory,
wherein the memory stores instructions that, when executed, cause the at least one processor to:
control to display on the display operation-related information of at least one environment creation device corresponding to a content, in response to a content playing event being detected,
set an operation mode of the at least one environment creation device, and
control the at least one environment creation device based on the set operation mode through the communication interface.

2. The electronic device of claim 1, wherein the operation-related information of the at least one environment creation device comprises at least one of identification information of the environment creation device, current operation mode information, user account information corresponding to a current operation mode, or recommendation operation mode information.

3. The electronic device of claim 1,
wherein the instructions cause the at least one processor to:
control to display on the display a user interface for setting the operation mode of the environment creation device, based on a user input, and
wherein the user interface comprises at least one of a power on/off setting item, an operation mode setting item, or an operation mode recovery setting item.

4. The electronic device of claim 1, wherein the instructions cause the at least one processor to:
control to display on the display information of at least one content output device corresponding to the content,
set whether to share the content with the at least one content output device, based on a user input, and
control to connect to the at least one content output device based on whether the content is set to be shared through the communication interface.

5. The electronic device of claim 4, wherein the instructions cause the at least one processor to:
control the communication interface to transmit content information to a server in response to the content plying event being detected, and
control to receive, from the server, at least one of the operation-related information of the at least one environment creation device or information of the at least one content output device.

6. The electronic device of claim 4, wherein the instructions cause the at least one processor to:
control to display on the display information indicating whether the at least one content output device is used by another electronic device.

7. The electronic device of claim 6, wherein the information indicating whether the at least one content output device is used by the other electronic device comprises at least one of user identification information of the other electronic device, user priority information, identification information of the other electronic device, or priority information of the other electronic device.

8. The electronic device of claim 1, wherein each of the at least one environment creation device and the at least one content output device is selected based on at least one of content information, a convergence configuration designated by a user, a using history of the electronic device, real-time states of neighboring electronic devices, a location of the electronic device, locations of the neighboring electronic devices, surrounding environment information, or time.

9. A server comprising:
a communication interface;
a memory; and
at least one processor operatively connected with the communication interface and the memory,
wherein the memory stores instructions that, when executed, cause the at least one processor to:
control to receive content information from an electronic device, and
control the communication interface to transmit operation-related information regarding at least one environment creation device corresponding to the content to the electronic device, in response to the content information being received from the electronic device.

10. The server of claim 9, wherein the operation-related information of the at least one environment creation device comprises at least one of identification information of the environment creation device, current operation mode information, user account information corresponding to a current operation mode, or recommendation operation mode information.

11. The server of claim 9, wherein the instructions cause the at least one processor to:
control the communication interface to transmit information of at least one content output device corresponding to the content to the electronic device.

12. The server of claim 11, wherein the instructions cause the at least one processor to:
select at least one of the at least one environment creation device or the at least one content output device, based on at least one of the content information, a convergence configuration designated by a user, a using history of the electronic device, real-time states of neighboring electronic devices related to the electronic device, a location of the electronic device, locations of the neighboring electronic devices, surrounding environment information, or time.

13. The server of claim 11, wherein the information of the at least one content output device comprises identification information of the content output device, and information indicating whether the content output device is used by another electronic device.

14. The server of claim 13, wherein the information indicating whether the content output device is used by the other electronic device comprises at least one of user identification information of the other electronic device, user priority information, identification information of the other electronic device, or priority information of the other electronic device.

15. The server of claim 11, wherein the instructions cause the at least one processor to:
control to store operation-related information regarding at least one of the at least one environment creation device or the at least one content output device,
detect a content playing end event of the electronic device, and
in response to the content playing end event being detected, control an operation of at least one of the at least one environment creation device or the at least one content output device based on the stored information.

16. The server of claim 11, wherein the instructions cause the at least one processor to:
control to receive, from the electronic device, a signal including setting information regarding at least one of the at least one environment creation device or the at least one content output device, and
control the communication interface to transmit a control signal to at least one of the at least one environment creation device or the at least one content output device based on the received signal.

17. An operating method of an electronic device, the operating method comprising:
in response to a content playing event being detected, displaying on a display of the electronic device operation-related information of at least one environment creation device corresponding to a content;
setting an operation mode of the at least one environment creation device; and
controlling the at least one environment creation device based on the set operation mode through the communication interface.

18. The operating method of claim 17, wherein the operation-related information of the at least one environment creation device comprises at least one of identification information of the environment creation device, current operation mode information, user account information corresponding to a current operation mode, or recommendation operation mode information.

19. The operating method of claim 17, further comprising:
displaying information of at least one content output device corresponding to the content,
setting whether to share the content with the at least one content output device, based on a user input, and
connecting to the at least one content output device based on whether the content is set to be shared.

20. The operating method of claim 17, further comprising:
displaying on the display a user interface for setting the operation mode of the environment creation device, based on a user input,
wherein the user interface comprises at least one of a power on/off setting item, an operation mode setting item, or an operation mode recovery setting item.
